(19) United States
(12) Patent Application Publication
(10) Pub. No.: US 2017/0090852 A1
(43) Pub. Date: Mar. 30, 2017

(54) INFORMATION PROCESSING APPARATUS, INFORMATION PROCESSING METHOD, AND STORAGE MEDIUM

(71) Applicant: NEC Corporation, Tokyo (JP)

(72) Inventor: Chihiro HARADA, Tokyo (JP)

(73) Assignee: NEC Corporation, Tokyo (JP)

(21) Appl. No.: 15/275,880

(22) Filed: Sep. 26, 2016

(30) Foreign Application Priority Data
Sep. 29, 2015 (JP) 2015-191022

(51) Int. Cl. G06F 3/14; G06F 3/0482

(52) U.S. Cl. CPC G06F 3/1454; G06F 3/0482; G06F 2203/04803

(57) ABSTRACT

An information processing apparatus according to an exemplary aspects of the present disclosure includes: a memory that stores a set of instructions; and at least one processor configured to execute the set of instructions to: calculate a relevance degree that indicates strength of relevance of a first area to a second area other than the first area on a basis of an operation related to the first area, the first area and the second area being in a plurality of areas in a screen shared by a plurality of terminal apparatuses; and send the relevance degree to the plurality of terminal apparatuses, the plurality of terminal apparatuses each displaying the screen based on the relevance degree.

This application is based upon and claims the benefit of priority from Japanese Patent Application No. 2015-191022, filed on Sep. 29, 2015, the disclosure of which is incorporated herein in its entirety by reference.

### TECHNICAL FIELD

The present disclosure relates to a technology of processing information.

### BACKGROUND ART

In recent years, electronic whiteboards comes to be widely used as electronic blackboards and as whiteboard functions at Web conferences. The electronic whiteboard is a virtual canvas (hereinafter, referred to also as screen) shared by a plurality of terminal apparatuses connected via a communication network. The electronic whiteboard can be operated by each of the plurality of terminal apparatuses that share an electronic whiteboard. The electronic whiteboard is provided by, for example, a server apparatus that is communicably connected with the plurality of terminal apparatuses. Examples of operations in an electronic whiteboard include drawing, moving, and deleting objects such as texts, graphics, and images.

Japanese Unexamined Patent Publication No. 2009-163458 describes a display apparatus that, when a window in a window system is switched to an active window, restores a window state associated with the window.

### SUMMARY

One of objects of the present disclosure is to provide an information processing system capable of restraining the decrease in operating efficiency even when the number of objects drawn on a screen increases.

An information processing apparatus according to an exemplary aspect of the present disclosure includes: a memory that stores a set of instructions; and at least one processor configured to execute the set of instructions to: calculate a relevance degree that indicates strength of relevance of a first area to a second area other than the first area on a basis of an operation related to the first area, the first area and the second area being in a plurality of areas in a screen shared by a plurality of terminal apparatuses; and send the relevance degree to the plurality of terminal apparatuses, the plurality of terminal apparatuses each displaying the screen based on the relevance degree.

An information processing method according to an exemplary aspect of the present disclosure includes: calculating a relevance degree that indicates strength of relevance of a first area to a second area other than the first area on a basis of an operation related to the first area, the first area and the second area being in the plurality of areas in a screen shared by a plurality of terminal apparatuses; and sending the relevance degree to the plurality of terminal apparatuses, the plurality of terminal apparatuses each displaying the screen based on the relevance degree.

A non-transitory computer-readable storage medium according to an exemplary aspect of the present disclosure storing a program that causes a computer to execute: relevance degree processing of calculating a relevance degree that indicates strength of relevance of a first area to a second area other than the first area on a basis of an operation related to the first area, the first area and the second area being in the plurality of areas in a screen shared by a plurality of terminal apparatuses; and control processing of sending the relevance degree to the plurality of terminal apparatuses, the plurality of terminal apparatuses each displaying the screen based on the relevance degree.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a configuration of an information processing system according to a first exemplary embodiment of the present disclosure;

FIG. 2 is a diagram schematically representing characteristics of electronic whiteboards;

FIG. 3 is a diagram schematically representing characteristics of areas;

FIG. 4 is a diagram schematically representing characteristics of objects;

FIG. 5 is a diagram schematically representing an example of relevance degrees and scores thereof;

FIG. 6 is a diagram schematically representing an example of a relation between execution numbers of operation and relevance scores;

FIG. 7 is a diagram schematically representing an example of operation information stored in an operation information storage unit;

FIG. 8 is a diagram schematically representing an example of a relation between intervals between areas in the time of creation and the relevance score;

FIG. 9 is a diagram schematically representing an example of a relation between distances and the relevance scores;

FIG. 10 is a diagram schematically representing an example of relevance degrees;

FIG. 11 is a diagram schematically representing an example of a screen that a terminal apparatus displays;

FIG. 12 is a diagram representing an example of a configuration of an information processing system according to a modification of the first exemplary embodiment of the present disclosure;

FIG. 13 is a first sequence chart illustrating an example of an operation of the information processing system according to the first exemplary embodiment of the present disclosure;

FIG. 14 is a second sequence chart illustrating an example of an operation of the information processing system according to the first exemplary embodiment of the present disclosure;

FIG. 15 is a first flowchart representing an example of an operation of the information processing system according to the first exemplary embodiment of the present disclosure;

FIG. 16 is a second flowchart representing an example of an operation of the information processing system according to the first exemplary embodiment of the present disclosure;

FIG. 17 is a third flowchart representing an example of an operation of the information processing system according to the first exemplary embodiment of the present disclosure;

FIG. 18 is a block diagram representing a configuration of an information processing system according to a second exemplary embodiment of the present disclosure; and

FIG. 19 is a diagram representing an example of a hardware configuration of a computer with which an information processing apparatus and a terminal apparatus that are included in the information processing system according to an exemplary embodiment of the present disclosure can be implemented.

### EXEMPLARY EMBODIMENTS

Before exemplary embodiments of the present disclosure are described, an electronic whiteboard achieved by an exemplary embodiment of the present disclosure will be described in a more detailed manner.

When many objects are disposed on an electronic whiteboard or when an electronic whiteboard is large in size, information displayed on the entire surface of the electronic whiteboard cannot be easily grasped. In such a case, dividing the electronic whiteboard into a plurality of regions makes it easy to group pieces of information. Such regions are referred to as “areas” below. Various objects, such as texts, graphics, or images, can be drawn in each of the areas.

A user of such electronic whiteboards is allowed to create, on a single electronic whiteboard, different areas for different purposes, for example. Then, the user selects an area in which the user is to perform an operation and performs the operation in the area by operating an input unit, such as a keyboard or a touch panel, of a terminal apparatus which the user uses. As mentioned above, examples of such an operation include drawing, moving, changing, and deleting objects. Performing such an operation in a selected area is referred to as “editing an area”.

On an electronic whiteboard that provides such areas for users, it is possible to add areas on the same electronic whiteboard and continuously perform editing. However, while a plurality of users can freely create areas, it is not always the case that all the areas are organized and aligned. As more areas are created in the electronic whiteboard, it is more likely that areas related in content to an area that is currently edited are scattered in the whiteboard. Therefore, it often becomes difficult to browse areas related to a currently edited area. If the electronic whiteboard allows users to edit areas while organizing and aligning areas, the users can easily browse areas related to the currently edited areas.

More detailed description is provided below. For example, on an electronic whiteboard shared by users who develop a product that has a plurality of functions, areas may be created separately for development phases of each of the functions. Examples of areas created in such a case include, for each function, an overview study area, an area for sharing investigation results, an area for studying implementation modes, an area for studying changes in specifications, an area for studying countermeasures when a problem occurs, and so forth. In this manner, sometimes, many areas are created on a single electronic whiteboard.

Sometimes when editing on an electronic whiteboard, a user does editing while browsing areas related to the currently edited area. When many areas are created on an electronic whiteboard, there is a possibility that areas related to a currently edited area are scattered in the whiteboard. In such a case, browsing areas related to the currently edited area is not easy. If the electronic whiteboard allows a user to do editing while organizing and aligning the areas that the user uses, the problem that a user not being able to find an area that the user wishes to browse can be prevented. However, if the number of such areas is large, it takes the user much time and trouble to manually organize the areas. Furthermore, organizing areas by a user can modify the content and arrangement of areas for another user. In that case, the another user would find it difficult to grasp the content shown on the electronic whiteboard.

### First Exemplary Embodiment

Next, a first exemplary embodiment of the present disclosure is described in detail with reference to the accompanying drawings.

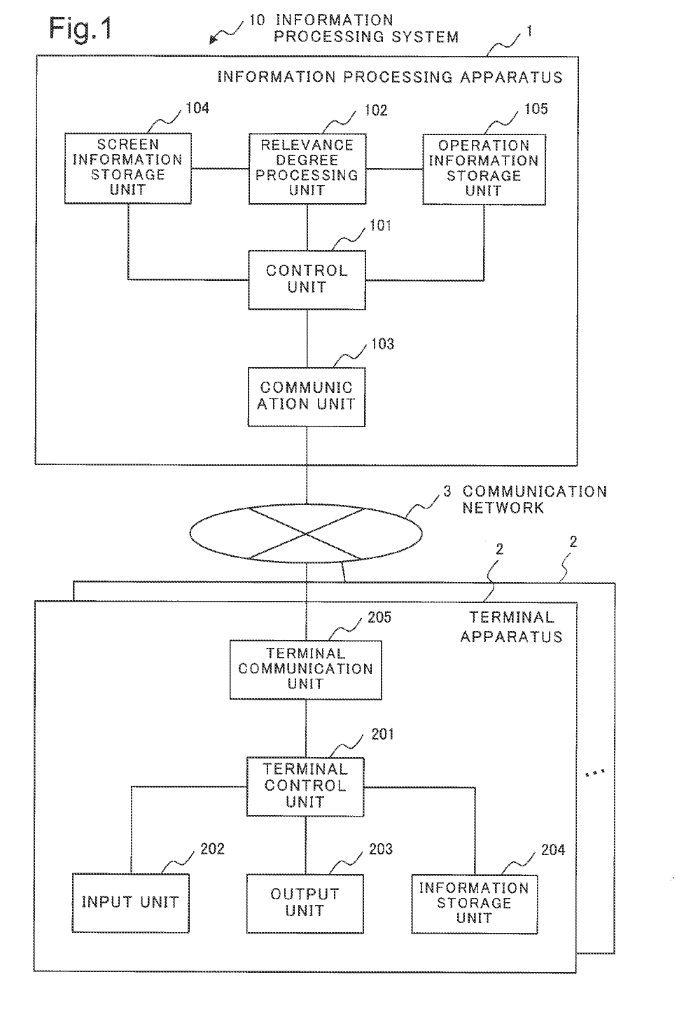

FIG. 1 is a block diagram illustrating an example of a configuration of an information processing system according to the present exemplary embodiment.

Referring to FIG. 1, an information processing system 10 of the present exemplary embodiment includes an information processing apparatus 1 and a plurality of terminal apparatuses 2. The information processing apparatus 1 is communicably connected with the terminal apparatuses 2 via a communication network 3. The information processing apparatus 1 provides electronic whiteboards as described above for the plurality of terminal apparatuses 2.

The information processing apparatus 1 includes a control unit 101, a relevance degree processing unit 102, a communication unit 103, a screen information storage unit 104, and an operation information storage unit 105.

Each of the terminal apparatus 2 includes a terminal control unit 201, an input unit 202, such as a keyboard or a touch panel, an output unit 203, such as a display or a touch panel, an information storage unit 204, and a terminal communication unit 205.

The screen information storage unit 104 stores characteristics of electronic whiteboards provided by the information processing apparatus 1, characteristics of areas generated on each of the electronic whiteboards, and characteristics of objects disposed in each of the areas.

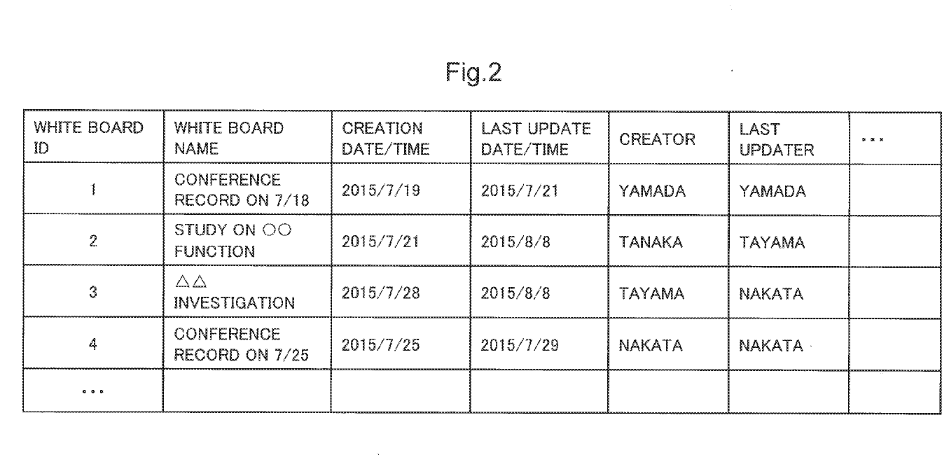

FIG. 2 is a diagram schematically representing characteristics of electronic whiteboards. Examples of the characteristics of an electronic whiteboard include an electronic whiteboard identification (ID) that identifies the electronic whiteboard, a name of the electronic whiteboard, date and time of creation thereof, date and time of the last update, a creator, the last updater, and the like.

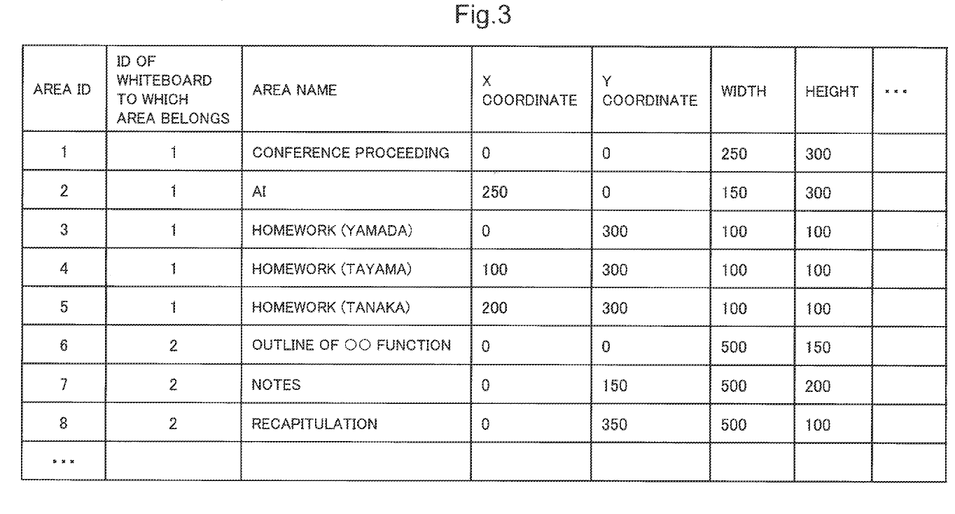

FIG. 3 is a diagram schematically representing characteristics of areas. The characteristics of an area include an area ID that identifies the area, the electronic whiteboard ID of the electronic whiteboard on which the area is created, a name of the area, a position of the area (e.g., an X coordinate and a Y coordinate), a size of the area (e.g., a width and a height), and the like.

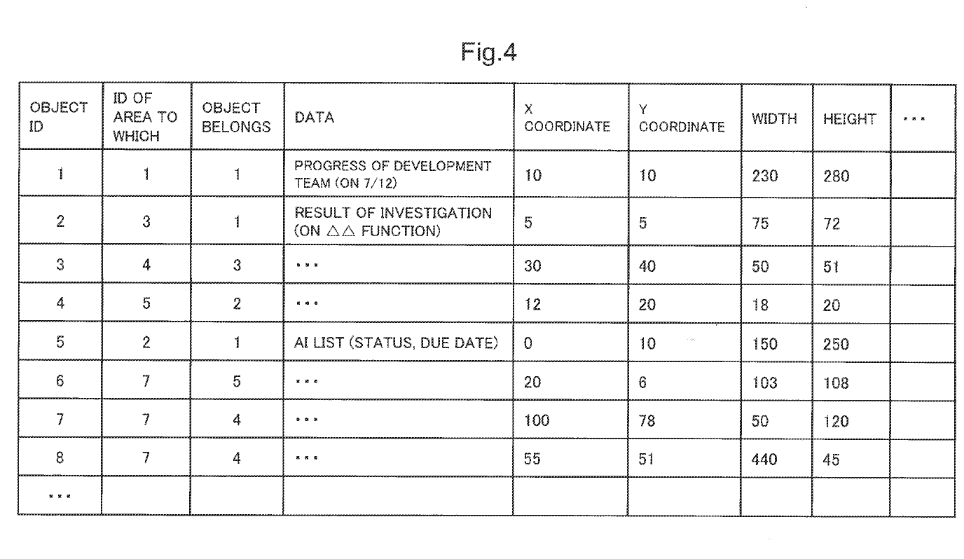

FIG. 4 is a diagram schematically representing characteristics of objects. The characteristics of an object include the area ID of the area in which the object is disposed, the electronic whiteboard ID of the electronic whiteboard in which that area is created, a kind of the object, content of the object, a position and size thereof, and the like. In the following description, information that is stored in the screen information storage unit 104 and that includes the characteristics of an electronic whiteboard, an area, and an object is referred to also as “characteristic information”. Furthermore, the characteristic information is referred to also as “whiteboard data”.

The information storage unit 204 of a terminal apparatus 2 stores the characteristics of an area on an electronic whiteboard that a user of the terminal apparatus 2 uses, the characteristics of the electronic whiteboard on which the area is created, the characteristics of an object disposed in the area.

The screen information storage unit 104 further stores a relevance degree between areas, for individual pairs of areas. The screen information storage unit 104 may further store a relevance score for individual determination factors for individual pairs of areas. The relevance degree and the determination factors will be described in detail later.

The terminal control unit 201 of a terminal apparatus 2 generates a screen of an area of an electronic whiteboard on the basis of the characteristic information stored in the information storage unit 204. The terminal control unit 201 displays the generated screen on the output unit 203. The terminal control unit 201 may generate a screen and display the generated screen on the output unit 203 as the characteristic information stored in the information storage unit 204 is updated. The terminal control unit 201 may also generate a screen and display the generated screen on the output unit 203 at intervals of a predetermined length. The terminal control unit 201, as described later, updates the characteristic information stored in the information storage unit 204 when an operation performed by an operator of the terminal apparatus 2 is input and also when operation information that indicates an operation performed on another terminal apparatus 2 is received.

An operator who operates a terminal apparatus 2 inputs an operation into the terminal apparatus 2 via the input unit 202, for example, a keyboard or a touch panel. The input unit 202 sends information that indicates the operation input to the terminal apparatus 2 to the terminal control unit 201.

The terminal control unit 201 receives, from the input unit 202, the information that indicates the operation input to the terminal apparatus 2. The terminal control unit 201 updates, on the basis of the operation which is performed by the operator and which is indicated by the information received, the characteristic information stored in the information storage unit 204. Furthermore, the terminal control unit 201 sends the operation information that indicates the operation performed by the operator to the information processing apparatus 1 via the terminal communication unit 205.

The information that the input unit 202 sends and that indicates an operation input via the input unit 202 includes, for example, the input data and a position of the operation. Examples of the input data include a character string that is input, a figure that is input, and information that identifies a kind of an operation, such as information that indicates a click of a mouse button, information that indicates a drag, information that indicates a touch on the touch panel, information that indicates a flick, and information that indicates a tap. The position of an operation is, for example, represented by coordinates on a screen where the operation is performed. The position of an operation may include a time series of coordinates.

On the basis of the information indicating an operation and received from the input unit 202, the terminal control unit 201 specifically determines content of the operation. The content of the operation may be selection of an electronic whiteboard. The content of the operation may be selection, creation, deletion, or the like of an area. The content of the operation may be selection, a modification, generation, duplication, a move, deletion, or the like of an object. A move of an object may be a move of the object within the same area, a move of the object between areas generated on the same electronic whiteboard, a move of the object between areas generated on different electronic whiteboards, or the like. Duplication of an object may be generating duplication of the object in the same area, generating duplication of the object in another area generated on the same electronic whiteboard, generating duplication of the object in an area generated on a different electronic whiteboard, or the like.

The operation information of an operation may include an object ID of an object on which the operation is performed. The operation information may include an area ID of an area on which the operation is performed. The operation information may include an electronic whiteboard ID of an electronic whiteboard on which the area is generated. The operation information may include a positon of a location at which the operation is performed. The operation information may include a user ID of an operator who performs the operation. The operation information may include a terminal ID of a terminal apparatus 2 on which the operation is performed. The operation information may include information about the time at which the operation is performed.

The control unit 101 of the information processing apparatus 1 receives, from a terminal apparatus 2 that displays a screen of an electronic whiteboard via the communication unit 103, the operation information indicating an operation input to the terminal apparatus 2.

Then, the control unit 101, on the basis of the operation information received from the terminal apparatus 2 as in the example described above, updates the characteristic information stored in the screen information storage unit 104. In other words, the control unit 101 reflects the content of the operation identified on the basis of the operation information in the characteristic information stored in the screen information storage unit 104. The control unit 101 stores an operation history that includes the content of the operation identified on the basis of the operation information into the operation information storage unit 105. The operation history may include a user ID of an operator who performs the operation whose content is included in the operation history. The operation history may include a terminal ID of a terminal apparatus 2 on which the operation whose content is included in the operation history is performed.

The control unit 101 sends the received operation information to the terminal apparatuses 2 other than the terminal apparatus 2 from which the received operation information is sent.

The information processing apparatus 1, because of, for example, the configuration as described above, provides electronic whiteboards to the terminal apparatuses 2.

The relevance degree processing unit 102 of the information processing apparatus 1 may calculate a relevance degree indicating a strength of relevance of an area on which an operation is performed to another area on the basis of the operation related to the area, which is included in a screen that includes a plurality of areas and that is shared by a plurality of terminal apparatuses 2.

Specifically, when an operation related to two or more areas is performed, the relevance degree processing unit 102 may calculate the relevance degrees indicating relevance between the areas to which the operation is related so that the relevance is strengthened. As is described later, an operation related to two or more areas is, for example, an operation of duplicating an object disposed in an area to another area (or two or more other areas). An operation related to two or more areas may be, for example, an operation of moving an object disposed in an area to another area (or two or more other areas).

Furthermore, when a predetermined kind of operation (referred to also as a predetermined operation) is performed, the relevance degree processing unit 102 may calculate the relevance degree indicating the relevance of an area related with the operation to an area related with an operation selected from a history of operations (i.e., the operation history described above) so that the relevance is strengthened. The predetermined kind of operation described above is, for example, an operation of selecting an area. In this case, an area related with the operation is the area selected by the operation. The predetermined kind of operation described above may be an operation of generating an area. In that case, an area related with the operation is the area generated by the operation. The predetermined kind of operation described above may be an operation of selecting an area and an operation of generating an area. The information processing system 10 may be configured so that, when an area is generated, the generated area becomes a state selected by the user who has generated that area. The relevance degree processing unit 102 may extract, from the operation history described above, an operation whose kind is the same as the predetermined kind and that is performed within a predetermined time period based on the time point at which the predetermined kind of operation is performed. The relevance degree processing unit 102 may calculate the relevance degree representing strength of relevance between the area on which the predetermined kind of operation described above is performed and an area on which the extracted operation is performed so that the relevance is strengthen. The relevance degree processing unit 102 may calculate a relevance degree representing relevance between two areas among the area in which the predetermined operation described above is performed and areas which are extracted so that strengthen the relevance is strengthen.

The relevance degree processing unit 102 may also extract, from the operation history, an operation performed by a user who performs the predetermined kind of operation described above after the time that is a predetermined time period before the predetermined kind of operation is performed. The relevance degree processing unit 102 may extract, from the operation history, one or more operations performed by a user who performs an operation of selecting an area before the operation and after the user performs the latest operation of selecting the same area before the operation of selecting the area. The relevance degree processing unit 102 may extract, at the time point at which the predetermined operation described above is performed, the area currently selected on the electronic whiteboard that includes the area where the operation is performed. This corresponds to processing that the relevance degree processing unit 102 extracts, from the operation history, an operation that is performed latest, before the predetermined operation described above is performed, by a terminal apparatus 2 other than the terminal apparatus 2 where the predetermined operation is performed, and identifies the area where the extracted operation is performed. The relevance degree processing unit 102 may extract an area that is selected immediately before the predetermined operation described above by the user who performs the predetermined operation. This corresponds to processing that the relevance degree processing unit 102 extracts, from the operation history, an operation that is performed latest before the predetermined operation described above is performed by the terminal apparatus 2 where the predetermined operation is performed, and identifies the area where the extracted operation is performed.

When an operation that changes a distance between areas on an electronic whiteboard (simply referred to also as screen) is performed, the relevance degree processing unit 102 may calculate the relevance degree between the areas on the basis of the changed distance therebetween. The operation that changes a distance between areas on an electronic whiteboard may be an operation of generating an area, an operation of changing a size of an area, an operation of moving an area, an operation of deleting an area, or the like. When a distance between areas is shortened, the relevance degree processing unit 102 may calculate the relevance degree indicating relevance between the areas so that the relevance is increased. When a distance between areas is strengthened, the relevance degree processing unit 102 may calculate the relevance degree indicating relevance between the areas so that the relevance is weakened.

In the foregoing description, the expressions that refer to “calculating the relevance degree so that the relevance is strengthened” mean calculating the relevance degree so that the relevance between the areas that the relevance degree indicates is strengthened. The expressions that refer to “calculating the relevance degree so that the relevance is weakened” mean calculating the relevance degree so that the relevance between the areas that the relevance degree indicates is weakened.

The relevance degree processing unit 102 calculates a relevance degree that represents the strength of relevance between areas as in examples presented below.

In the following description, the relevance degree between an area m and an area n will be expressed as R(m, n) (where m and n are the numbers assigned to the areas). The relevance degree processing unit 102 calculates as a relevance degree R(m, n), the sum of scores Si(m, n) based on a plurality of determination factors, (where i is the number assigned to a determination factor). In the following description, the score based on a determination factors is also referred to as “score of determination factors”. The relevance degree processing unit 102 may calculate as a relevance degree R(m, n) the sum of the scores Si(m, n) of determination factors multiplied by a weight (hereinafter, referred to as “ai”) that is not necessarily the same. The determination factor indicates a criterion for determining a strength of relevance. The relevance degree R(m, n) can be represented by the following expression. The weight ai may be, for example, preset by a user of the information processing system 10 according to use.

$$R ( m , n ) = {\sum }_{i} {a}_{i} {S}_{i} ( m , n ) \qquad [ Math . 1 ]$$

In the present exemplary embodiment, the relevance degree processing unit 102 calculates the relevance degree between areas, for example, by scores based on the following determination factors. The determination factors are not limited to the following examples.

(First determination factor) Duplication or move of an object over areas

(Second determination factor) Areas selected by more than one user at the same time point

(Third determination factor) A selection history of areas

(Fourth determination factor) The time of creation of areas

(Fifth determination factor) A just previously selected area at creation of an area

(Sixth determination factor) Distance between areas

These determination factors will be briefly described below

(First Determination Factor) Duplication or Move of an Object Over Areas

Duplication of an object over areas means disposing a duplicate of an object, which is disposed in an area, in another area. Two areas over which duplication or move of an object is performed are highly likely to include mutually related contents. Therefore, the relevance degree processing unit 102 may determine a relevance score between two areas over which duplication or move of an object is performed to become high. When an operation is duplication or move of an object over different areas, the relevance degree processing unit 102 updates the relevance score based on the first determination factor.

(Second Determination Factor) Areas Selected by More than One User at the Same Time Point

Areas that are on an electronic whiteboard and are selected by more than one user of the electronic whiteboard at the same time point are highly likely to have descriptions of mutually related contents. Therefore, the relevance degree processing unit 102 may determine relevance scores between areas that are selected by more than one user at the same time point to become high. When an operation performed by a user is an operation of selecting an area other than an area currently selected, the relevance degree processing unit 102 updates the relevance score based on the second determination factor.

(Third Determination Factor) A Selection History of Areas

Areas selected successively by a user are highly likely to include mutually related contents. The relevance degree processing unit 102 determines the relevance degree between areas on the basis of order of transition of areas selected by a user within a certain time. Specifically, the relevance degree processing unit 102 may determine, for example, a relevance score between areas included among areas selected successively within a constant time by a user to become high. The relevance degree processing unit 102 may determine the relevance score between two areas successively selected to become high. When an operation performed by a user is an operation of selecting an area other than an area currently selected, the relevance degree processing unit 102 updates the relevance score based on the third determination factor.

For example, when a user selects, is a state in which an area A is selected, areas in order of “the area A→an area B→the area A” within a certain time, the area A and the area B are highly likely to include mutually related contents. The relevance degree processing unit 102 determines the relevance score between the area A and the area B so that the relevance degree between the area A and the area B becomes high.

Similarly, when a user selects areas in order of “the area A→the area B→an area C→the area A” within a certain time, the relevance degree processing unit 102 determines relevance scores between the area A and the area B, between the area A and the area C, and between the area B and the area C so that the relevance degrees therebetween become high.

(Fourth Determination Factor) The Time of Creation of Areas

In general, topics of discussion tend to change over time. Therefore, the closer the areas are in the time of creation of areas on an electronic whiteboard that allows users to continuously perform editing while adding areas, the more likely the relevance therebetween is to become high. The relevance degree processing unit 102 may determine the relevance score so that the closer the areas are in the time of creation, the higher the relevance degree between the areas. When an operation performed by a user is an operation of creating an area, the relevance degree processing unit 102 updates the relevance score based on the fourth determination factor.

For example, when a problem is found during development of a product that has a plurality of functions as mentioned above by using an electronic whiteboard, it sometimes happens that work, such as identification of the problem, review of the specifications, and investigation of similar problems, may be performed in sequence. When information about the work is shared by using different areas newly created on the electronic whiteboard, areas whose contents relate to individual phases of the work mentioned above are created at mutually close times.

(Fifth Determination Factor) A Just Previously Selected Area Creation of an Area

A selected area that is selected before creating an area by a user who creates the area is highly likely to include a content related to the created area. The relevance degree processing unit 102 may determine the relevance score between a newly created area and an area that is selected just before creating the newly created area by the user who creates the newly created area to become high. When an operation performed by a user is an operation of creating an area, the relevance degree processing unit 102 updates the relevance score based on the fifth determination factor.

(Sixth Determination Factor) Distance Between Areas

The shorter the distance between the positions of two areas disposed in a screen of an electronic whiteboard, the more likely these areas are to include contents related to those areas. The relevance degree processing unit 102 may determine the relevance score between areas so that the closer the positions at which areas are disposed in a screen of the electronic whiteboard, the higher the relevance degree therebetween. When an operation is creation, move, or size change of an area, the relevance degree processing unit 102 updates the relevance scores based on the sixth determination factor. Furthermore, in the case where an electronic whiteboard is configured so that deletion of an area results in a changed arrangement of other areas, when an operation is deletion of an area, the relevance degree processing unit 102 updates the relevance score based on the sixth determination factor.

Next, operations of the information processing system 10 according to the present exemplary embodiment are described in detail with reference to the accompanying drawings.

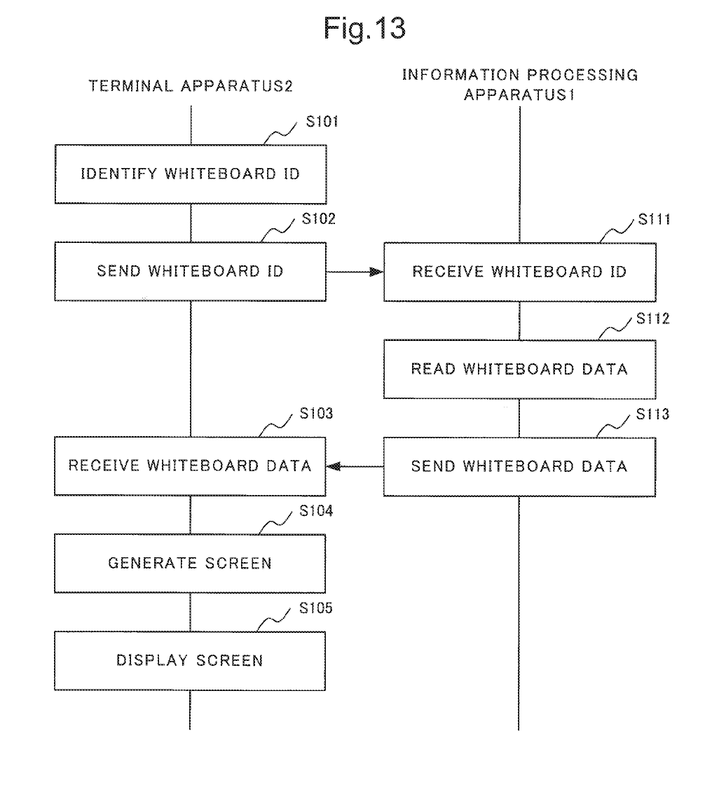

FIG. 13 is a sequence chart illustrating an example of an operation of the information processing system 10 according to the present exemplary embodiment. The operation illustrated in FIG. 13 represents an operation performed when a user of the terminal apparatus 2 opens an electronic whiteboard, that is, when a user starts using an electronic whiteboard.

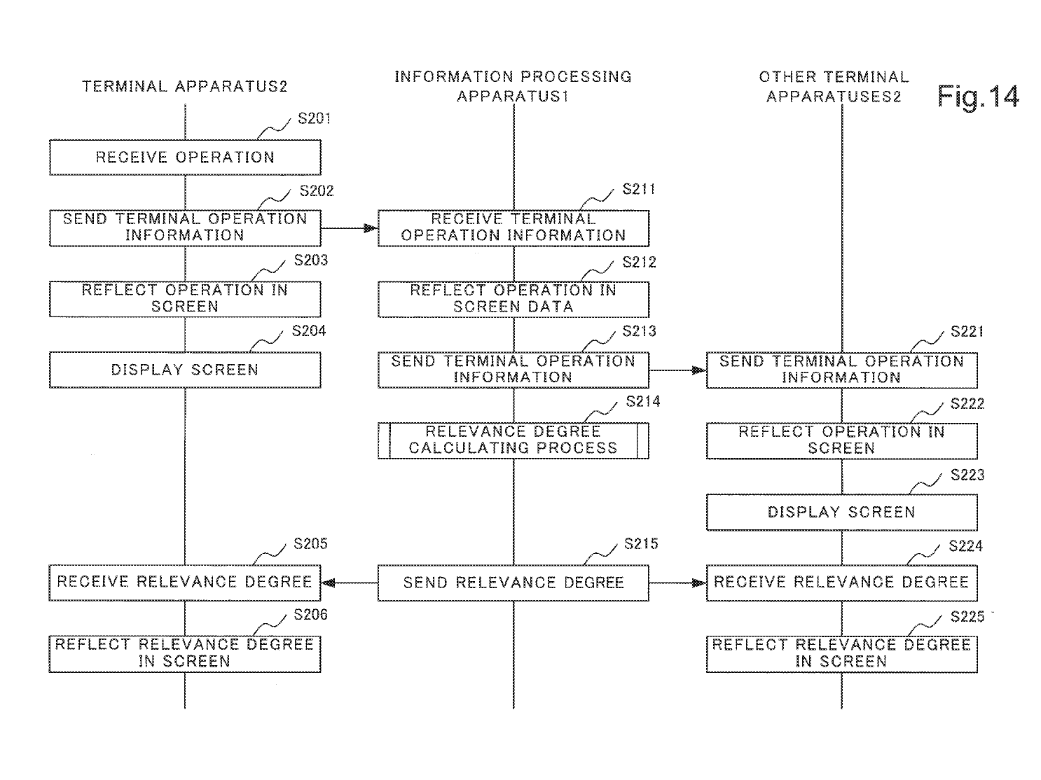

At the time of start of operation illustrated in FIG. 14, the terminal control unit 201 of the terminal apparatus 2, for example, requests the information processing apparatus 1 to send a list of electronic whiteboards. In response to the request for a list of electronic whiteboards, the information processing apparatus 1, for example, sends a list of electronic whiteboard IDs (hereinafter, also referred to simply as “whiteboard IDs”) to the terminal apparatus 2. The information processing apparatus 1 may send not only the whiteboard IDs but also names of the electronic whiteboards to the terminal apparatus 2. The terminal control unit 201 of the terminal apparatus 2 receives the whiteboard IDs via the terminal communication unit 205 and displays on the output unit 203 the list of the electronic whiteboards whose whiteboard IDs is received. The list of electronic whiteboards, which is displayed, may be a list of whiteboard IDs. The list of electronic whiteboards, which is displayed, may also be a list of names of the electronic whiteboards or the like. The user of the terminal apparatus 2, using the input unit 202, selects an electronic whiteboard to use from the list of electronic whiteboards. The input unit 202 sends to the terminal control unit 201, data that represent the user's operation of selecting an electronic whiteboard.

The terminal control unit 201, on the basis of the above-described data received, identifies the whiteboard ID of the selected electronic whiteboard (step S101). For example, when the user's operation of selecting the electronic whiteboard is an operation of clicking a button of a mouse, an operation of tapping the screen, or the like, the terminal control unit 201 may identify the electronic whiteboard whose name or the like is displayed at the location of the clicking or tapping. For example, when the user's operation of selecting the electronic whiteboard is an operation of inputting a number, a character string or the like assigned to the electronic whiteboard, the terminal control unit 201 may identify the electronic whiteboard to which the number, the character string or the like, which is input, is assigned. Next, the terminal control unit 201 sends the whiteboard ID of the electronic whiteboard identified to the information processing apparatus 1 (step S102). The terminal control unit 201, by sending the whiteboard ID, requests the information processing apparatus 1 to send whiteboard data on the electronic whiteboard identified by the whiteboard ID.

The control unit 101 of the information processing apparatus 1 receives the whiteboard ID via the communication unit 103 (step S111). The control unit 101 reads from the screen information storage unit 104 whiteboard data on the electronic whiteboard identified by the received whiteboard ID, that is, the whiteboard data that the information processing apparatus 1 is requested to send (step S112). The control unit 101 sends the read whiteboard data to the terminal apparatus 2 that requests to send the whiteboard data (step S113). The information processing apparatus 1 stores the terminal ID of the terminal apparatus 2 as the terminal ID of the terminal apparatus 2 that is using the electronic whiteboard indicated by the whiteboard ID that the information processing apparatus 1 sends, for example, into the operation information storage unit 105.

The terminal control unit 201 of the terminal apparatus 2 receives the whiteboard data (step S103). The terminal control unit 201 generates a screen of the electronic whiteboard from the received whiteboard data (step S104). The terminal control unit 201 outputs the generated screen of the electronic whiteboard to the output unit 203 (step S113). The terminal control unit 201 may store the received whiteboard data into the information storage unit 204.

To end the use of the electronic whiteboard, the terminal control unit 201 of the terminal apparatus 2 may send the whiteboard ID of the electronic whiteboard and information indicating that the use of the electronic whiteboard is to end to the information processing apparatus 1. Then, the control unit 101 receives the whiteboard ID and the information indicating that the use of the electronic whiteboard is to end. The control unit 101 then deletes the terminal ID of the terminal apparatus 2 that sends the whiteboard ID and the information indicating that the use of the electronic whiteboard is to end from the group (list) of the terminal IDs of the terminal apparatuses 2 that use the electronic whiteboard indicated by the received whiteboard ID.

Next, an operation performed by the information processing system 10 of the present exemplary embodiment when a user has performed an operation is described in detail with reference to the accompanying drawings.

FIG. 14 is a sequence chart illustrating an example of an operation performed by the information processing system 10 of the present exemplary embodiment when a user performs an operation.

The operation that a user performs on the electronic whiteboard via the input unit 202 is sent to the information processing apparatus 1 via the terminal communication unit 205. The operation performed on the electronic whiteboard may be requesting to acquire data, creating or deleting an electronic whiteboard, changing the title or property of a whiteboard, creating, deleting, or editing an area, creating, deleting, or editing an object, or the like. The input unit 202 sends data representing the operation that the user performs to the terminal control unit 201.

The terminal control unit 201 receives the operation from the input unit 202 (step S201). In other words, the terminal control unit 201 receives the data that represents the operation that the user performs. On the basis of the received data, the terminal control unit 201 identifies the operation that the user performs and generates operation information that represents the identified operation. The terminal control unit 201 sends the generated operation information to the information processing apparatus 1 (step S202). The terminal control unit 201 reflects in the whiteboard data the operation that the user performs. Specifically, the terminal control unit 201 updates the whiteboard data on the basis of the operation that the user performs. The terminal control unit 201 reflects the operation performed by the user on the screen displayed in the output unit 203 (step S203). For example, the terminal control unit 201 may generate a screen of the electronic whiteboard by using the updated whiteboard data. The terminal control unit 201 may rewrite (or redraw) a portion of the screen of the whiteboard data which is to be modified due to the update of the whiteboard data. The terminal control unit 201 displays the screen of the electronic whiteboard updated according to the operation in the output unit 203 (step S204).

The control unit 101 of the information processing apparatus 1 receives operation information that is sent from a terminal apparatus 2 and that represents an operation performed on the electronic whiteboard, via the communication unit 103 (step S211). The control unit 101 reflects the operation represented by the operation information in the whiteboard data (referred to also as screen data) (step S212). The control unit 101 may, for example, read the whiteboard data on the electronic whiteboard on which the operation has been performed from the screen information storage unit 104. The control unit 101 may apply, to the read whiteboard data, modification that is caused by the operation represented by the operation information. Then, the control unit 101 may store the whiteboard data in which the received terminal operation information is reflected.

When the operation information indicates an operation of editing an electronic whiteboard, that operation needs to be reflected in the whiteboard data of the other terminal apparatuses 2 that use that electronic whiteboard. The control unit 101 identifies the terminal apparatuses 2 that use the electronic whiteboard that is edited. When any other terminal apparatuses 2 that use the edited electronic whiteboard exist and are identified, the control unit 101 sends the operation information to the identified terminal apparatuses 2 in order to reflect the performed operation in the whiteboard data of the identified terminal apparatuses 2 (step S213). The control unit 101 may send information indicating the modification in the whiteboard data that is caused by reflecting the operation to the identified other terminal apparatuses 2.

The control unit 101 sends the operation information to the relevance degree processing unit 102. The relevance degree processing unit 102 executes a relevance degree calculating process that calculates a relevance degree (step S214). The relevance degree calculating process will be described later in detail. When the operation represented by the operation information is an operation concerning the calculation of a relevance degree, i.e., an operation that may cause a relevance degree to change, the relevance degree processing unit 102 calculates a relevance degree by performing the relevance degree calculating process. When the operation represented by the operation information is not an operation concerning the calculation of a relevance degree, the relevance degree processing unit 102 does not calculate a relevance degree by the relevance degree calculating process. In that case, the relevance degree is not changed. When a relevance degree is calculated, the relevance degree processing unit 102 transmits the calculated relevance degree to the control unit 101. The control unit 101 sends the calculated relevance degree to each of the terminal apparatuses 2 that use the electronic whiteboard that the calculated relevance degree concerns (step S215). Each of the terminal apparatuses 2 receives the relevance degree from the control unit 101 (step S205 and step S224). Each of the terminal apparatuses 2 that receive the relevance degree reflects the received relevance degree in the screen (step S206 and step S225). The method of reflecting the relevance degree in a screen is described later in detail.

Next, an operation in which the information processing system 10 of the present exemplary embodiment calculates the relevance degree will be described in detail with reference to the accompanying drawings.

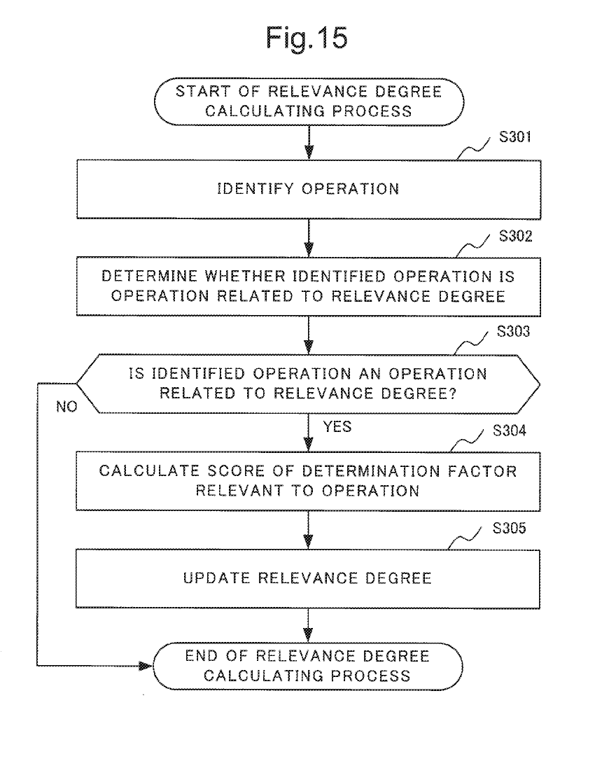

FIG. 15 is a flowchart representing an example of the operation in which the information processing system 10 of the present exemplary embodiment calculates the relevance degree.

The relevance degree processing unit 102 receives the operation information from the control unit 101. The relevance degree processing unit 102 identifies the operation indicated by the received operation information (step S301). The relevance degree processing unit 102 determines whether the identified operation is an operation related with a relevance degree (step S302). Specifically, the relevance degree processing unit 102 determines, for example, whether the identified operation meets any one of the above-described conditions for updating the scores based on the determination factors. When the identified operation is not an operation related to the relevance degree (NO in step S303), that is, when the identified operation does not meet any one of the conditions for updating the scores based on the determination factors, the relevance degree processing unit 102 ends the relevance degree calculating process illustrated in FIG. 15.

When the identified operation is an operation related to the relevance degree (YES in step S303), that is, when the identified operation meets any one of the conditions for updating the scores based on the determination factors, the relevance degree processing unit 102 calculates a score of the determination factor related to the operation (step S304). That is, the relevance degree processing unit 102 calculates the score based on the determination factor related to the condition for updating which the identified operation meets.

Incidentally, the determination factors are not limited to the six examples described above. The relevance degree processing unit 102 may calculate not only the relevance score based on the examples of the determination factors but also, for example, a relevance score based on similarity in text. For example, when the operation is an operation (e.g., generation, deletion, change, move, or the like) on an object that includes text, the relevance degree processing unit 102 may calculate the relevance score between areas on the basis of the relevance in text between all the objects that include text on the areas. The relevance between texts can be determined, for example, on the basis of whether the texts contain words that belong to the same category. For example, when two areas each have objects that contain words that belong to the same category, the relevance degree processing unit 102 may determine a relevance score between the areas so that the relevance score therebetween is high. Categories of words may be generated beforehand. The method of calculating the score based on relevance in text may be one of various methods for determining similarity between texts.

Next, on the basis of the updated relevance score, the relevance degree processing unit 102 updates the relevance degree according to the mathematical expression 1 described above (step S305). The relevance degree processing unit 102 stores the calculated score and the updated relevance degree into the operation information storage unit 105.

Next, an operation performed when the relevance degree is calculated on the basis of the above-described six examples of determination factors is described in detail with reference to the accompanying drawings.

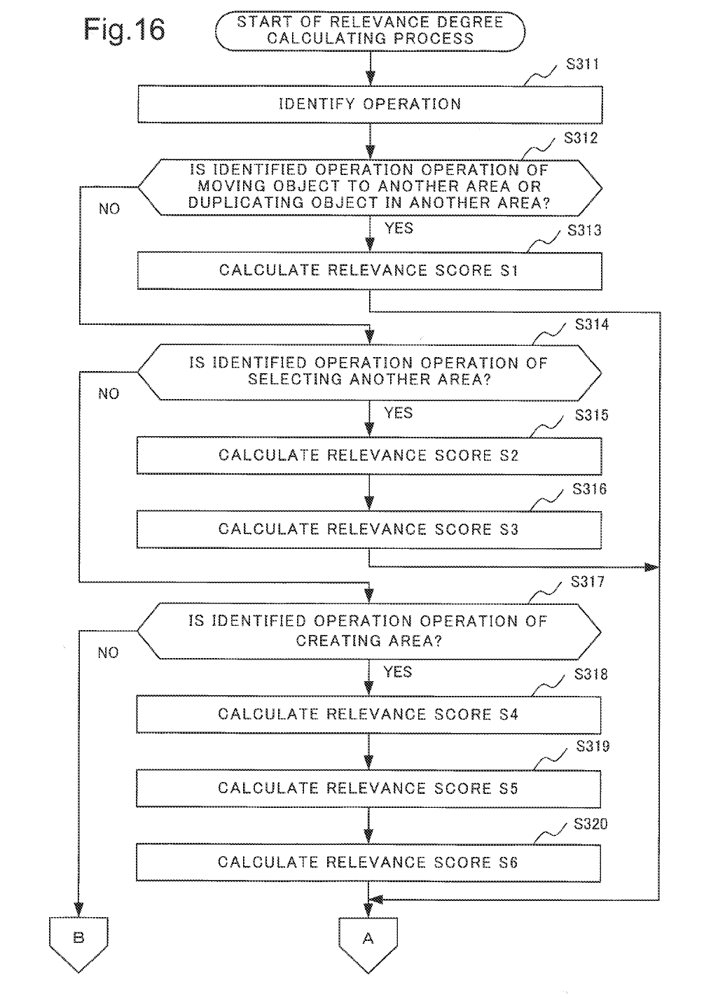

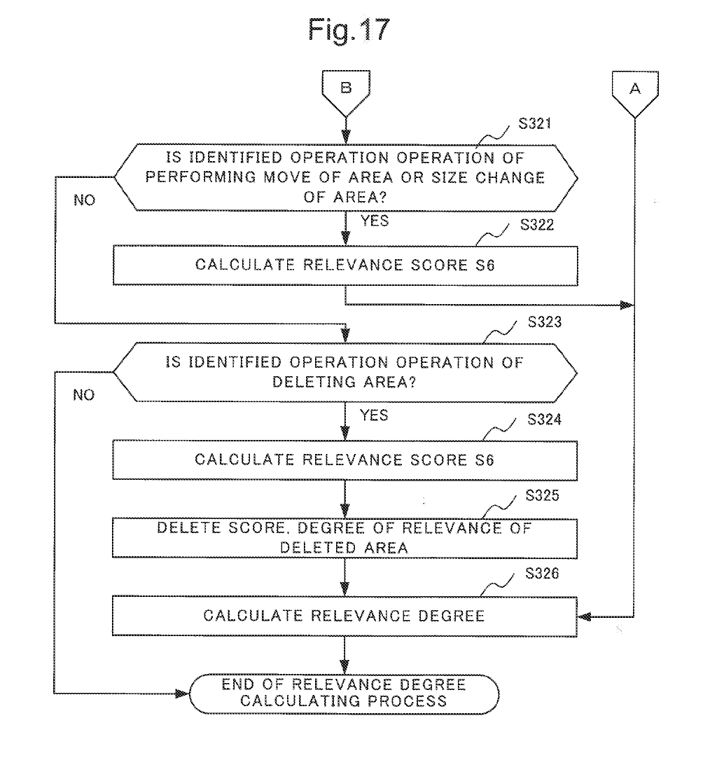

FIG. 16 and FIG. 17 are flowcharts illustrating an example of an operation of the relevance degree calculating process of the information processing system 10 of the present exemplary embodiment in which the relevance degree is calculated on the basis of the above-described six examples of determination factors. In FIG. 16 and FIG. 17, relevance scores S1 to S6 are scores based on the first to sixth determination factors, respectively.

The relevance degree processing unit 102 receives the operation information from the control unit 101. Then, as illustrated in FIG. 16, the relevance degree processing unit 102 identifies the operation indicated by the received operation information (step S311).

According to the above-described examples of determination factors, when the identified operation is duplication or move of an object over different areas (YES in step S321), the relevance degree processing unit 102 calculates the relevance score based on the first determination factor (step S313). The relevance degree processing unit 102 then performs the operation of step S326 shown in FIG. 17. When the identified operation is not move and duplication of an object over different areas (NO in step S312), the relevance degree processing unit 102 then performs the operation of step S314.

When the identified operation is an operation of selecting an area other than the currently selected area (YES in step S314), the relevance degree processing unit 102 calculates the relevance score based on the second determination factor and the relevance score based on the third determination factor (step S315 and step S316, respectively). The relevance degree processing unit 102 then performs the operation of step S326 in FIG. 17. When the identified operation is not an operation of selecting an area other than the currently selected area (NO in step S314), the relevance degree processing unit 102 then performs the operation of step S317.

When the identified operation is an operation of creating an area (YES in step S317), the relevance degree processing unit 102 calculates the relevance score based on the fourth determination factor, the relevance score based on the fifth determination factor, and the relevance score based on the sixth determination factor (steps S318, S319, and S320). The relevance degree processing unit 102 then performs the operation of step S326 shown in FIG. 17. When the identified operation is not an operation of creating an area (NO in step S317), the relevance degree processing unit 102 then performs the operation of step S321 in FIG. 17.

When the identified operation is move of an area or change of the size of an area (YES in step S321), the relevance degree processing unit 102 calculates the relevance score based on the sixth determination factor (step S322). Then, the relevance degree processing unit 102 performs the operation of step S326. When the identified operation is not move of an area or change of the size of an area (NO in step S321), the relevance degree processing unit 102 then performs the operation of step S323.

When the identified operation is deletion of an area (YES in step S323), the relevance degree processing unit 102 calculates the relevance score based on the sixth determination factor (step S324). The relevance degree processing unit 102 may delete the relevance degree and the relevance score that relate to the deleted area (step S325). Next, the relevance degree processing unit 102 performs the operation of step S326. When the identified operation is not deletion of an area (NO in step S323), the operation illustrated in FIG. 16 and FIG. 17 is ended.

In a case where the electronic whiteboard is configured so that deletion of an area does not change the positions of other areas, the information processing system 10 may not perform the operation of step S324 in FIG. 17. In that case, the information processing system 10 may end the operation illustrated in FIG. 16 and FIG. 17 after performing the operation of step S325.

Then, the relevance degree processing unit 102 calculates the relevance degree (step S326). Then, the operation illustrated in FIG. 16 and FIG. 17 ends.

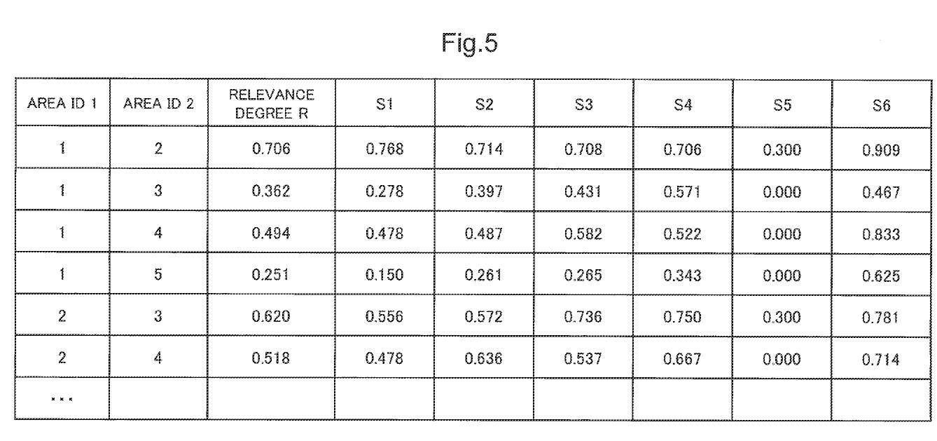

FIG. 5 is a diagram schematically representing an example of relevance degrees and relevance scores that are stored in the operation information storage unit 105. In the example shown in FIG. 5, the “relevance degree R” represents the relevance degree between areas identified by “area ID 1” and “area ID 2”. S1 to S6 are relevance scores between areas identified by the “area ID 1” and the “area ID 2” based on the first to sixth determination factors, respectively. In the following description, the scores based on determination factors is referred to also as “relevance scores”. The relevance scores based on the first to sixth determination factors are referred to as relevance scores S1 to S6, respectively.

A calculation method for scores (relevance scores) based on the first to sixth determination factors described above is described in detail below.

(First Determination Factor) Duplication or Move of an Object Over Areas

As described above, when the operation performed is duplication or move of an object, the relevance degree processing unit 102 identifies the area on which the operation is performed. When the performed operation is duplication or move of an object over different areas, the relevance degree processing unit 102 calculates the relevance score S1 of the area of the duplication source or the move source of the object on which the operation was performed and the relevance score S1 of the area of the duplication destination or the move destination. The relevance degree processing unit 102 stores the calculated relevance score S1 into the screen information storage unit 104. The relevance degree processing unit 102 may, for example, rewrite the updated relevance score of the relevance scores stored in the screen information storage unit 104 as in the form of the example shown in FIG. 5 to the calculated value.

The relevance degree processing unit 102 calculates the relevance score S1 so that the greater the number of times that duplication or move is performed between two areas, the higher the relevance score S1 over those two areas becomes. The relevance degree processing unit 102, for example, calculates the relevance score S1 by the following mathematical expression.

[Math. 2]

S(m,n)=1−Z(1−S_{OLD}(m,n)) (1)

The expression (1) is an expression of updating the relevance score between two areas (an area m and an area n). In the expression (1), S_{OLD}(m, n) is the relevance score S1 before updating and the initial value of the relevance score S1 is zero. The constant Z is a value by which a score is increased by one updating, that is, performing updating once. The constant Z is a value determined on the basis of how much a score is increased by one updating. The constant Z is determined within a range above 0 and below 1 (0<Z<1). Usually, the number of times that duplication or move of an object is performed between areas is not so many. Therefore, in order to make a large increase of a score for one updating, the value of Z may be, for example, set as Z=0.75. Incidentally, the expression (1) is merely an example, and the expression for calculating the relevance score S1 is not limited to the expression (1). When the performed operation is an operation of duplicating an object from an area to two or more areas, the relevance degree processing unit 102 may calculate the relevance score S1 of each of the combinations of a duplication source area and a duplication destination areas.

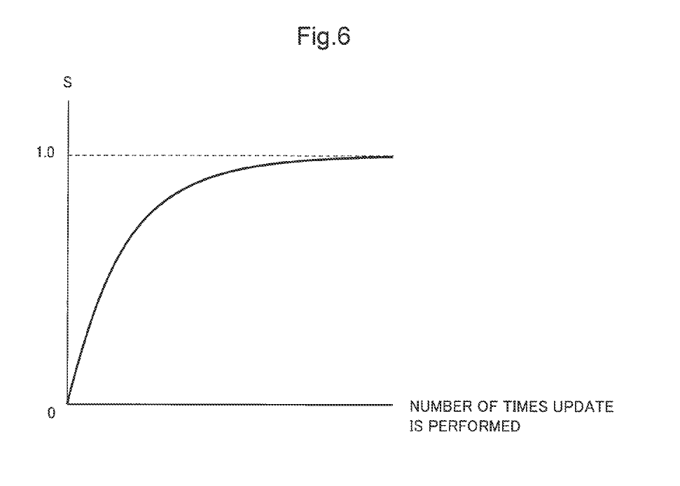

FIG. 6 is a diagram schematically representing an example of a relation between the numbers of times that an object is duplicated or moved between over and the relevance scores S1. When the relevance score S1 is calculated according to the expression (1), the relevance score between two areas approaches 1.0 with increases in the number of times that duplication or move of an object is performed over the two areas, as illustrated in FIG. 6.

(Second Determination Factor) Areas Selected Simultaneously by More than One User at the Same Time Point

When the performed operation is an operation of selecting an area, the relevance degree processing unit 102 calculates the relevance score S2 of each combination of two areas selected in the same electronic whiteboard by at least one of the users. The relevance degree processing unit 102 stores calculated relevance scores S2 into the screen information storage unit 104.

For example, when an area 1, an area 2, and an area 3 is selected by three users on an electronic whiteboard, respectively, the relevance degree processing unit 102 updates scores S2(1, 2), S2(1, 3), and S2(2, 3). A score S2(i, j) represents the relevance score S2 between an area i and an area j.

When an area is selected by two or more users, the relevance degree processing unit 102 updates the score related with the area for the number of times equal to the number of the users selecting the area. In the description of exemplary embodiments of the present disclosure, the score related with an area refers to the relevance score between the area and another area. For example, when the area 1 is selected by one user and the area 2 is selected by two users and the area 3 is selected by one user, the relevance degree processing unit 102 updates the score S2(1, 2) twice, updates the score S2(1, 3) once, and updates the score S2(2, 3) twice.

The relevance degree processing unit 102 may update the relevance score S2 according to the same expression (e.g., expression (1)) as is used to update the relevance score S1. The expression used to update the relevance score S2 is not limited to the example described above.

Usually, the operation of selecting an area is performed frequently. Therefore, in order to reduce the amount of increase of a score for one updating, the value of the constant Z may be, for example, set as Z=0.95.

(Third Determination Factor) A Selection History of Areas

When the operation performed by a user is an operation of selecting an area, the relevance degree processing unit 102 identifies an area selected by the user before performing the operation, on the basis of the operation information (e.g. a selection history) stored in the operation information storage unit 105. The relevance degree processing unit 102 may identify, for example, an area that is selected by a user who performs the latest operation of selecting an area and is selected after the time point that is a certain time prior to the time when the user performs the latest operation of selecting an area. Alternatively, the relevance degree processing unit 102 may identify an area that is selected by a user who performs the latest operation of selecting an area and is selected after the time point that is a certain time prior to the time when the relevance degree processing unit 102 starts processing of identifying the area. The relevance degree processing unit 102 calculates the relevance score S3 related with the identified areas area. The relevance degree processing unit 102 stores the calculated relevance score S3 into the screen information storage unit 104.

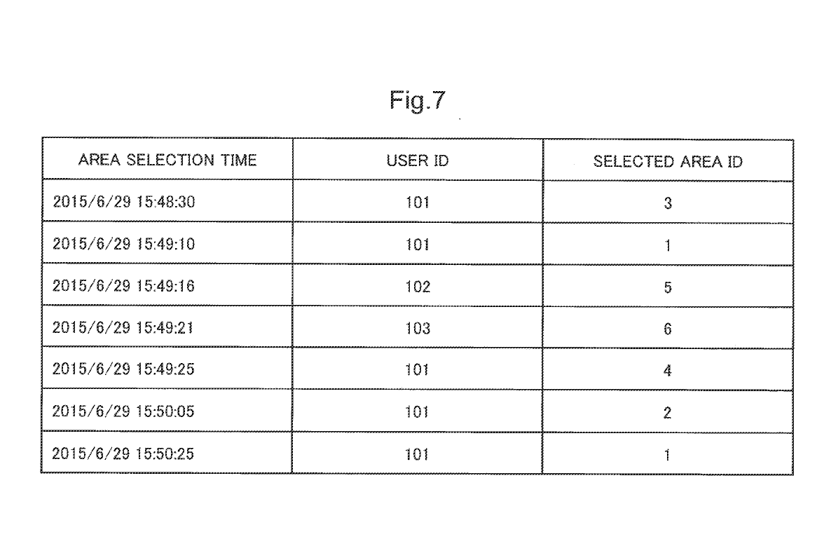

FIG. 7 is a diagram schematically representing an example of operation information stored in the operation information storage unit 105. The control unit 101 may store the operation information of an operation of selecting an area into the operation information storage unit 105. The control unit 101 may also delete operation information from the operation information storage unit 105 after a predetermined length of time passes since the operation information is stored. In the example shown in FIG. 7, the operation information stored in the operation information storage unit 105 for at least the predetermined length of time is deleted.

When a user performs an operation of selecting an area, the relevance degree processing unit 102 may read out, from the operation information storage unit 105, operation information of an operation of selecting an area performed by, for example, the user who performs the operation of selecting an area. The relevance degree processing unit 102 updates the relevance score S3 related with an area selected, for example, by the user who performs the operation of selecting an area after a time point that is a certain time prior to the time when the operation of selecting an area is performed by the user, by an operation of selecting an area. When the area that is selected latest is selected, for example, more than once after a time point that is a certain time before, the relevance degree processing unit 102 does not necessarily need to calculate all the relevance scores S3 related with areas selected after the time point that is the certain time before. The relevance degree processing unit 102 may update the relevance score S3 related with the area selected more than once and the relevance scores S3 related with an area selected between the latest two operations of selecting the area selected more than once.

In the example shown in FIG. 7, the user whose user ID is 101 (hereinafter, referred to as user A) selects an area 3, an area 1, an area 4, an area 2, and the area 1 in that order. In the example shown in FIG. 7, the area that the user A selects last is the area 1 selected on Jun. 29, 2015, at 15:50:25. According to the history shown in FIG. 7, the user A selects the area 1 also on Jun. 29, 2015, at 15:49:10. Therefore, the relevance degree processing unit 102 may identify all the areas that the user A selects between Jun. 29, 2015, 15:49:10 and Jun. 29, 2015, 15:50:25. In the example shown in FIG. 7, the user A selects the area 1, the area 4, and the area 2 between Jun. 29, 2015, 15:49:10 and Jun. 29, 2015, 15:50:25. The relevance degree processing unit 102 updates the relevance scores S3 related with the area 1, the relevance score S3 related with the area 4, and the relevance score S3 related with the area 2. In other words, the relevance degree processing unit 102 updates S3(1, 2), S3(1, 4), and S3(2, 4). Note that S3(i, j) represents the relevance score S3 between an area i and an area j.

The relevance degree processing unit 102 may update (i.e., calculate) the relevance score S3 according to the expression (1) in the same way as in the case when calculating the relevance score S1. The expression (1) is an example of a mathematical expression for deriving the relevance score S3. The expression for calculating the relevance score S3 is not limited to the example described above.

Usually, the operation of selecting an area is frequently performed. Therefore, in order to reduce the amount of increase in the score per update, the value of the constant Z may be set, for example, as Z=0.95.

(Fourth Determination Factor) The Time of Creation of Areas

When an operation performed is an operation of adding an area, the relevance degree processing unit 102 identifies the added area and an area already existing at the time of addition of that area. Then, the relevance degree processing unit 102 calculates the relevance score S4 between the added area and the identified existing area. The relevance degree processing unit 102 stores the calculated relevance score S4 into the screen information storage unit 104.

The relevance degree processing unit 102 calculates the relevance score S4 so that the closer the areas in the time of creation, the higher the relevance score S4 between the areas becomes. The relevance degree processing unit 102 may calculate the relevance score S4, for example, according to the following expression.

[Math. 3]

S(m,n)=W/(|C(m)−C(n)|+W) (2)

The expression (2) is an expression for calculating the relevance score between two areas (e.g., an area m and an area n). S(m, n) is the relevance score between the two areas and “/” is an operator that represents division. C(m) and C(n) are the time (second) of creation of an area m and the time of creation of an area n, respectively. W is a coefficient that determines how much the difference in the time of creation decreases the score. The calculation expression (2) is an example of an expression for calculating the relevance score S4. The expression for calculating the relevance score S4 is not limited to the example described above.

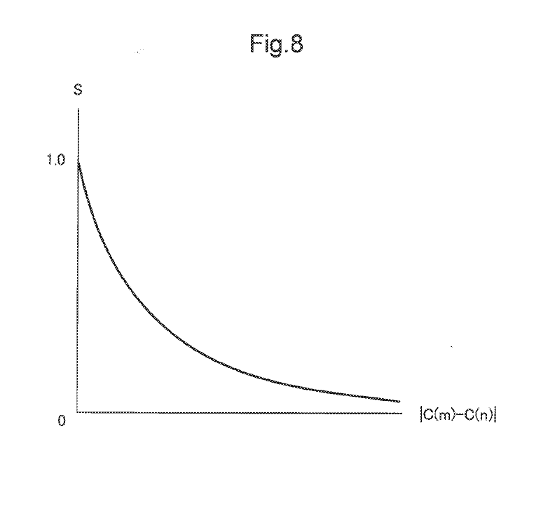

FIG. 8 is a diagram schematically representing a relation between the intervals between areas in the time of creation and the relevance scores between the areas based on the expression (2). In FIG. 8, |C(m)−C(n)| on the horizontal axis represents the interval between the time points of creation of areas.

The score based on the expression (2) becomes closer to zero as the interval between areas in the time of creation increases, as in the example shown in FIG. 8.

For example, when the value of W is set as “W=432000” and the time difference between areas in the time of creation is 10 minutes (600 seconds), the relevance score S4 is as follows. In the following expression, “÷” is an operator that represents division.

S4=43200÷(600+43200)=0.986

When the difference in the time of creation is 2 hours (7200 seconds), the relevance score S4 is as follows.

S4=43200÷(7200+43200)=0.857

When the difference in the time of creation is one day (86400 seconds), the relevance score S4 is as follows.

S4=43200÷(86400+43200)=0.333

(Fifth Determination Factor) A Just Previously Selected Area at Creation of an Area

When an operation performed is an operation of adding an area, the relevance degree processing unit 102 calculates the relevance score S5 between an area added and an already existing area selected just previously, for example, by the following expression. The relevance degree processing unit 102 stores the calculated relevance score S5 into the screen information storage unit 104.

[Math. 4]

S(m,n)=V (3)

The expression (3) is an expression for calculating the relevance score between two areas (i.e., an area m and an area n). S(m, n) is the relevance score between the two areas. V is a coefficient that determines to what extent to set the relevance degree between a newly created area and a just previously selected area at the time of creation of the newly created area. The expression (3) is an example of an expression for calculating the relevance score S5. The expression for calculating the relevance score S5 is not limited to the example described above.

In the expression (3), when the value of the constant V is set, for example, as V=0.3, the relevance score S5 between the newly created area and the area selected just previously at the time of creation of the newly created area is 0.3.

(Sixth Determination Factor) Distance Between Areas

When an operation performed is an operation causing a relative position of areas on the electronic whiteboard to change, the relevance degree processing unit 102 identifies the areas whose relative position changes. Then, the relevance degree processing unit 102 updates the relevance score S6 of combinations of areas whose relative positions changes. The operation that result in a change in a relative position of areas on the electronic whiteboard may be addition, deletion, move, size change or the like of an area. The relative position of areas on the electronic whiteboard is a distance between positions at which the areas are disposed on the electronic whiteboard. When an operation performed is an operation causing a relative position of areas on the electronic whiteboard to change, the relevance degree processing unit 102 identifies the areas whose position or size is changed due to the operation. The relevance degree processing unit 102 calculates the relevance scores S6 between the identified area and other areas. The relevance degree processing unit 102 stores the calculated relevance scores S6 into the screen information storage unit 104.

The relevance degree processing unit 102 calculates the relevance score S6 so that the shorter the distance between areas, the higher the relevance degree between the areas becomes. The relevance degree processing unit 102 calculates the relevance scores S6, for example, by the following expression.

[Math. 5]

S(m,n)=U/(D(m,n)+U (4)

The expression (4) is an expression for calculating the relevance score between two areas (i.e., an area m and an area n). S(m, n) represents the relevance score between the two areas. D(m, n) represents the distance (number of pixels) between the center coordinates of the two areas. The constant U is a coefficient that determines how much the score decreases according to the distance. The expression (4) is an example of the expression for calculating the relevance score S6. The expression for calculating the relevance score S6 is not limited to the foregoing example.

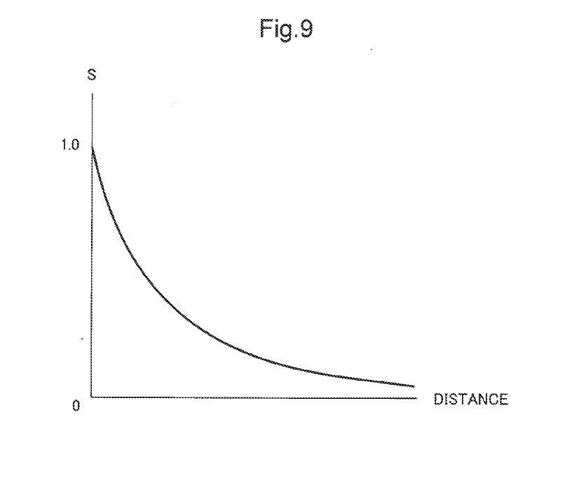

FIG. 9 is a diagram schematically representing a relation between the distance and the relevance score based on the expression (4).

As illustrated in FIG. 9, as the distance between areas becomes longer, the relevance score therebetween based on the expression (4) becomes closer to zero.

For example, when the value of the constant U is set as “U=5000” and the distance between coordinates of centers of areas is 500 pixels, the relevance score S6 between the areas based on the expression (4) is as follows.

S6=5000÷(500+5000)=0.909

When the distance is 1000 pixels, the relevance score S6 is as follows.

S6=5000÷(1000+5000)=0.833

When the distance is 10000 pixels, the relevance score S6 is as follows.

S6=5000÷(10000+5000)=0.333

Next, calculation of the relevance degree based on the relevance score is described. The relevance degree processing unit 102 calculates the relevance degree, for example, by the following expression. The following expression is an expression for calculating the relevance degree on the basis of the relevance scores S1 to S6. In the following expression, R(m, n) represents the relevance degree between an area m and an area n. Si(m, n) (i=1, . . . , 6) represents the relevance scores S1 to S6 and αi represents weight coefficients of the relevance scores S1 to S6. The weight coefficient αi may be determined beforehand. The weight coefficient αi may be normalized so that the sum thereof equals to 1.

$$\begin{matrix}[ Math . 6 ] & \\ R ( m , n ) = {\sum }_{i}^{6} {α}_{i} {S}_{i} ( m , n ) & ( 5 )\end{matrix}$$

Next, the calculation of the relevance degree when the values of the weight coefficients α1 to α6 of the relevance scores S1 to S6 are as mentioned below will be specifically described.

α1=0.3,α2=0.15,α3=0.2,α4=0.15,α5=0.1,α6=0.1

For example, when the relevance score between the area 1 and the area 2 is a value indicated in FIG. 5, the relevance degree R(1, 2) between the area 1 and the area 2 based on the expression (5) is as follows.

R(1,2)=0.3×0.768+0.15×0.714+0.2×0.708+0.15×0.706+0.1×0.300+0.1×0.909=0.706

In the example described above, normalization is performed so that the sum of the weight coefficients αi is 1.0.

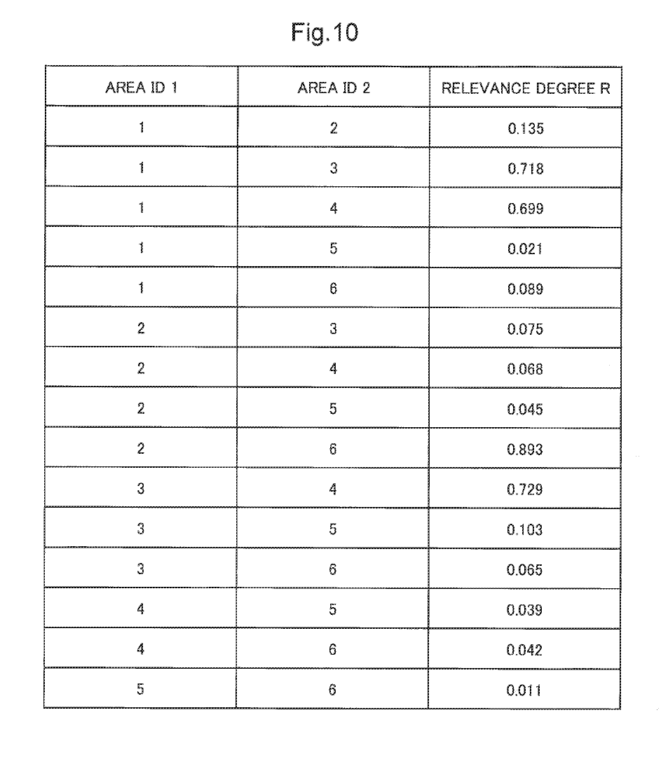

FIG. 10 is a diagram schematically representing an example of the relevance degree calculated, for example, as described above.

Next, display of areas that the terminal apparatuses 2 perform on the basis of the relevance degree is described.

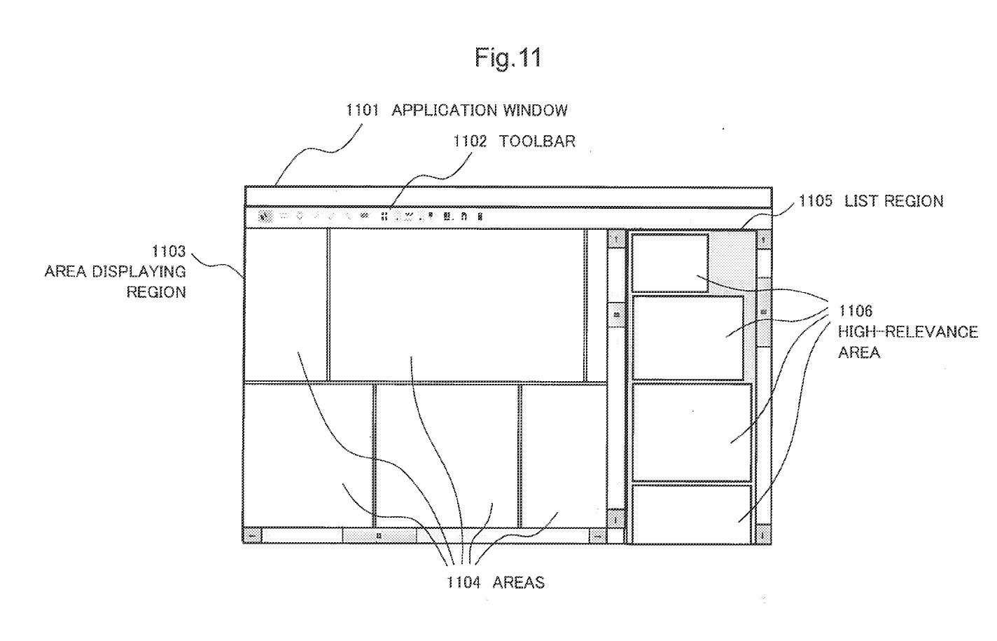

FIG. 11 is a diagram schematically representing an example of a screen that the terminal apparatuses 2 display. The terminal control unit 201 may generate an application window, for example, shown in FIG. 11, as mentioned above, as a screen of the electronic whiteboard on the basis of the whiteboard data stored in the information storage unit 204. The terminal control unit 201 may display the generated screen (i.e., the application window) on the output unit 203.

In the example shown in FIG. 11, an application window 1101 is a window that displays the screen of the electronic whiteboard. The terminal control unit 201 displays on the application window 1101 a toolbar 1102, an area display region 1103, and a list region 1105. The positional relation among the toolbar 1102, the area display region 1103, and the list region 1105 is not limited to the example showman FIG. 11. For example, the toolbar 1102 may be displayed at the right of, the left of, or below the area display region 1103. The toolbar 1102 may also be displayed in a window other than the application window 1101. The list region 1105 may be displayed at the left of, above, or below the area display region 1103. The list region 1105 may be displayed in a window separate from the application window 1101. The terminal control unit 201 displays, in the toolbar 1102, menus that allow a user to use various functions when browsing and editing the electronic whiteboard and areas on the electronic whiteboard. The terminal control unit 201 provides, via the toolbar 1102, various functions that can be used at the time of browsing and editing the electronic whiteboard and areas on the electronic whiteboard. The area display region 1103 is a region that displays areas created on the electronic whiteboard. The area display region 1103 is a main region where the user browses and edits the electronic whiteboard. The terminal control unit 201 displays, in the area display region, areas 1104 created on the electronic whiteboard. The above-described distance between areas disposed on the electronic whiteboard is, for example, the distance between areas disposed in the area display region 1103. The terminal control unit 201 displays in the list region 1105 a list of areas that have high relevance degrees with the area currently selected by the user, for example, in the form of size-reduced images of the areas or the like. High-relevance areas 1106 are display of areas having high relevance degrees with the currently selected area. The high-relevance areas 1106 are, for example, size-reduced images of the areas having high relevance degrees with the area currently selected by the user, as mentioned above. The high-relevance areas 1106 may be size-reduced images of such areas, images of such areas, such areas themselves, or the like.

According to the above-described example of the relevance degree, when the user selects an area, the relevance degree processing unit 102 updates the relevance degrees that relate to the selected area on the basis of the operation of selecting the area. As the above description of the operation of step S215 shown in FIG. 14, the control unit 101 of the information processing apparatus 1 may send, when the relevance degree between areas is updated, the updated relevance degree to the terminal apparatuses 2 that are using the electronic whiteboard on which those areas is created. In that case, the terminal control unit 201 of each of the terminal apparatus 2 may, for example, generate a list of areas sorted in order of relevance degrees related with the selected area on the basis of the received relevance degrees. The list of areas is, for example, a sequence of area IDs. The list of areas may also be, for example, a sequence of combinations of area IDs and the relevance degrees. The list of areas may also be other data by which the order of areas is identified.

When the user selects an area, the terminal control unit 201 of the terminal apparatus 2 may request the information processing apparatus 1 to provide a list of areas sorted in order of relevance degrees related with the selected area.

In that case, the control unit 101 of the information processing apparatus 1 receives a request to provide the list described above (hereinafter, referred to as request for a list) via the communication unit 103. The request for a list may include the area ID of the area selected by the user. In the request for a list, the area ID of the area selected by the user may be designated. The control unit 101, after receiving the request for a list from the terminal apparatus 2, sends the area ID of the area designated in the request for a list to the relevance degree processing unit 102. Receiving the area ID, the relevance degree processing unit 102 generates a sequence of area IDs of areas arranged in order of relevance degrees related with the area identified by the received area ID. The relevance degree processing unit 102 sends the generated sequence of the area IDs as the above-described list of areas back to the control unit 101. The control unit 101 sends the received list of areas to the terminal apparatus 2 via the communication unit 103.

The terminal control unit 201 receives from the information processing apparatus 1 the list of areas that includes the sequence of area IDs arranged in order of relevance degrees. On the basis of the received list of areas, the terminal control unit 201 displays the areas in order of relevance degrees, for example, in the list region 1105. The terminal control unit 201 may display size-reduced images of the areas in the list region 1105 as mentioned above. Also as mentioned above, the terminal control unit 201 may display the areas in the list region 1105 without reducing the size of the areas.

Accordingly, the user of the terminal apparatus 2 can edit the electronic whiteboard while referring to areas having high relevance degrees with the currently selected area.

The terminal control unit 201 may also display in the list region 1105 the area selected by the user (e.g., an image, a size-reduced image, or the like of the area selected by the user). In that case, the terminal control unit 201 may display, for example, the area selected by the user in an uppermost portion of the list region 1105, and the other areas, below the area selected by the user, in order of the relevance degree with the selected area.

The terminal control unit 201 may also detect, in the list region 1105, designation of a high-relevance area 1106 made by the user (as, for example, a click of a mouse button, a tap of the touch panel, or the like in a high-relevance area 1106). When designation of a high-relevance area 1106 is detected, the terminal control unit 201 may change the position at which the area 1104 indicated by the high-relevance area 1106 whose designation is detected is displayed in the area display region 1103 to the designated position in the area display region 1103. The designated position is, for example, an uppermost portion of the area display region 1103. The designated position may also be, for example, a central portion of the area display region 1103. The terminal control unit 201 may carry out the changing of the position at which an area displayed in the area display region 1103 by changing the position at which the area is displayed in the area display region 1103 on the screen of the electronic whiteboard (by, e.g., scrolling).

The terminal control unit 201 may also change the size of the area displayed in the area display region 1103 on the basis of the relevance degree related with the area selected by the user. For example, the terminal control unit 201 may display the areas 1104 in the area display region 1103 so that the higher the relevance degree of an area 1104, which is related with the area selected by the user, the lower the size reduction rate of the area 1104.

In that case, for example, the relevance degree processing unit 102 may calculate the relevance degrees, for example, by carrying out normalization, so that the values of the relevance degrees are greater than or equal to 0 and less than or equal to 1. The reduction rate of an area is represented by, for example, the following expression. In the following expression, R is a relevance degree normalized so that the value thereof is greater than or equal to 0 and less than or equal to 1. Q is the reduction rate of the area.

Q=0.5+R/2.0 [Math. 7]

Because of displaying the areas 1104 in the area display region 1103 so that the higher the relevance degree of an area 1104, which is related with the area selected by the user, the lower the reduction rate of that area, the number of high-relevance areas displayed in the area display region 1103 increases. Therefore, the convenience in editing and the ease of browsing improve. The terminal control unit 201 may cause the areas whose relevance degrees are lower than a threshold value to not be displayed.

The terminal control unit 201 may change the position at which an area is displayed in the area display region 1103 on the basis of the relevance degree related with the area selected by the user. The terminal control unit 201 may display, for example, an area nearer to the area selected by the user as the relevance degree of the area, which is related with the area selected by the user, becomes higher.

The terminal control unit 201 may group areas on the basis of the relevance degrees. The terminal control unit 201 may generate groups of areas so that a combination of areas having high relevance degrees is in a same group. In the example of relevance degrees shown in FIG. 10, as a value of relevance degree becomes greater, the value represents the stronger relevance, that is, the higher relevance degree. In FIG. 10, the relevance degrees R(1, 3), R(1, 4), R(3, 4), and R(2, 6) are greater in value than the relevance degrees between other areas. That is, the relevance degrees between areas represented by the relevance degrees R(1, 3), R(1, 4), R(3, 4), and R(2, 6) are higher than the relevance degrees between the other areas. In this case, the terminal control unit 201 can, for example, classify the area 1, the area 3, and the area 4 into one group, classify the area 2 and the area 6 into another group, and classify the area 5 into still another group.

The present exemplary embodiment described above has an advantageous effect of being able to restrain decline in operating efficiency even if objects drawn in a screen increase in number.

A reason is that the relevance degree processing unit 102 calculates relevance degrees that represent the strengths of relevance of areas with an area selected by the user. For example, on the basis of the calculated relevance degrees, the terminal control unit 201 of each of the terminal apparatuses 2 can change the screen of an electronic whiteboard displayed in the output unit 203 so that the user can easily access areas that have high relevance degrees related with the area selected by the user. In that case, even if objects drawn on the screen increase in number, decline in operating efficiency can be inhibited.

In the present exemplary embodiment described above, the information processing apparatus 1 is implemented as an apparatus other than the terminal apparatuses 2. However, one of the terminal apparatuses 2 may operate as the information processing apparatus 1.

(Modifications of First Exemplary Embodiment)

In the information processing system 10 according to the present exemplary embodiment, as described above, the terminal control unit 201 of a terminal apparatus 2 generates a screen that is displayed in the output unit 203 of that terminal apparatus 2. However, the configuration of the information processing system 10 is not limited to the example described above.

For example, the information processing apparatus 1 may further include a drawing unit 106 that generates a screen that is displayed by the output unit 203 of each of the terminal apparatuses 2 connected with the information processing apparatus 1.

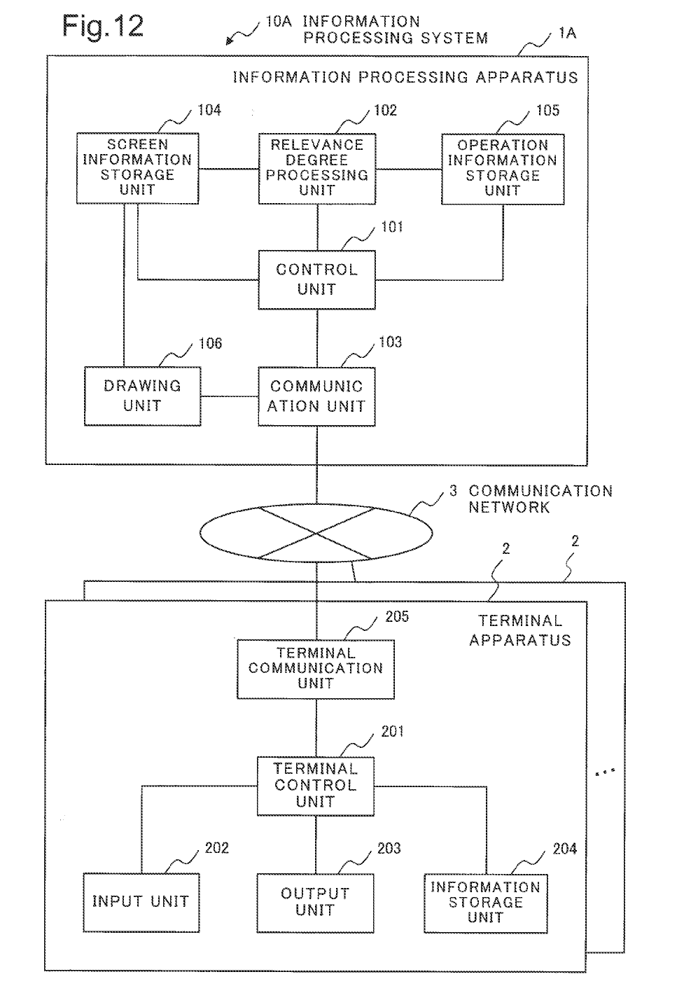

FIG. 12 is a diagram illustrating an example of a configuration of an information processing system 10A according to a modification of the present exemplary embodiment which includes the drawing unit 106. Compared with the information processing system 10 shown in FIG. 1, the information processing system 10A shown in FIG. 12 includes an information processing apparatus 1A instead of the information processing apparatus 1. Compared with the information processing apparatus 1, the information processing apparatus 1A further includes a drawing unit 106. The information processing system 10A is the same as the information processing system 10, except for the differences described below.

The drawing unit 106 generates a screen of an electronic whiteboard on the basis of characteristics of the electronic whiteboard, characteristics of areas, and characteristics of objects that are stored in the screen information storage unit 104. The drawing unit 106 sends the generated screen of the electronic whiteboard to each of the terminal apparatuses 2 using the electronic whiteboard via the communication unit 103. For example, the drawing unit 106 may periodically send the generated screen of the electronic whiteboard to each of the terminal apparatuses 2 using the electronic whiteboard.

The terminal communication unit 205 of each of the terminal apparatuses 2 receives the screen of the electronic whiteboard from the information processing apparatus 1 via the communication network 3. The terminal control unit, for example, displays the received screen on the output unit 203, which is a display device.

The control unit 101 receives, from a terminal apparatus 2, operation information indicating an operation input to the terminal apparatus 2 that displays the screen of the electronic whiteboard via the communication unit 103. The control unit 101 identifies the content of the operation that the received operation information indicates. The control unit 101 may identify the object on which the operation indicated by the operation information is performed, on the basis of, for example, the received operation information and the characteristics stored in the screen information storage unit 104.

The control unit 101 reflects the content of the operation identified on the basis of the operation information in the characteristic information stored in the screen information storage unit 104. The control unit 101 stores an operation history that includes the content of the operation identified on the basis of the operation information into the operation information storage unit 105. The operation history may include the user ID of the operator who performs the operation whose content is included the operation history. The operation history may include the terminal ID of the terminal apparatus 2 on which the operation whose content is included in the operation history.

In this modification, the drawing unit 106 generates the screen of the electronic whiteboard, for example, as shown in FIG. 11, on the basis of the relevance degree stored in the screen information storage unit 104. The display of areas performed on the screen of the electronic whiteboard on the basis of the relevance degrees by the drawing unit 106 according to the modification is the same as the display of areas performed on the basis of the above-described relevance degrees by the terminal control unit 201 of the first exemplary embodiment.

### Second Exemplary Embodiment

Next, a second exemplary embodiment of the present disclosure will be described in detail with reference to the accompanying drawings.

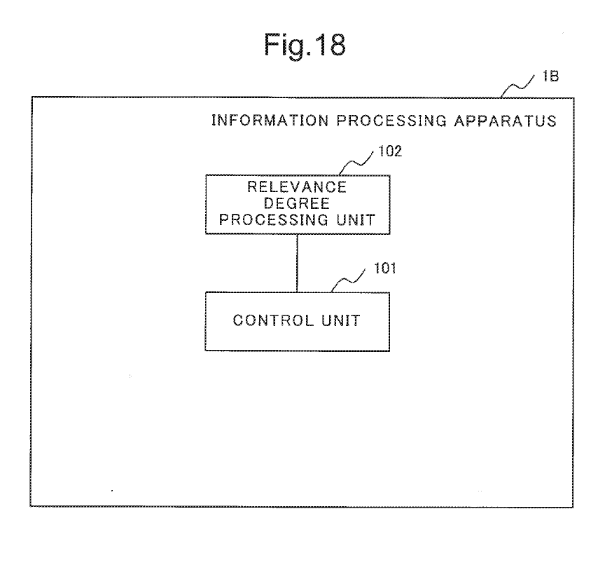

FIG. 18 is a block diagram illustrating a configuration of an information processing apparatus 1B according to the present exemplary embodiment.

Referring to FIG. 18, the information processing apparatus 1B of the present exemplary embodiment includes a relevance degree processing unit 102 and a control unit 101. The relevance degree processing unit 102 calculates, on the basis of an operation related to two or more areas in a screen that are shared by two or more terminal apparatuses, a relevance degree that represents the strength of relevance between an area, of the two or more areas, on which that operation is performed and the other one or more areas of the two or more areas. The control unit 101 sends the relevance degree to a terminal control unit 201 of each of the terminal apparatuses 2 which generates the screen on the basis of the relevance degree.

The present exemplary embodiment described above has the same advantageous effects as the first exemplary embodiment described above. A reason is the same reason why the first exemplary embodiment achieves the advantageous effects described above.

### Other Exemplary Embodiments

The information processing apparatus 1, the information processing apparatus 1A, the information processing apparatus 1B, and the terminal apparatuses 2 each can be achieved with a computer and a program that controls the computer, a dedicated hardware apparatus, or a combination of a computer, a program that controls the computer, and a dedicated hardware apparatus.

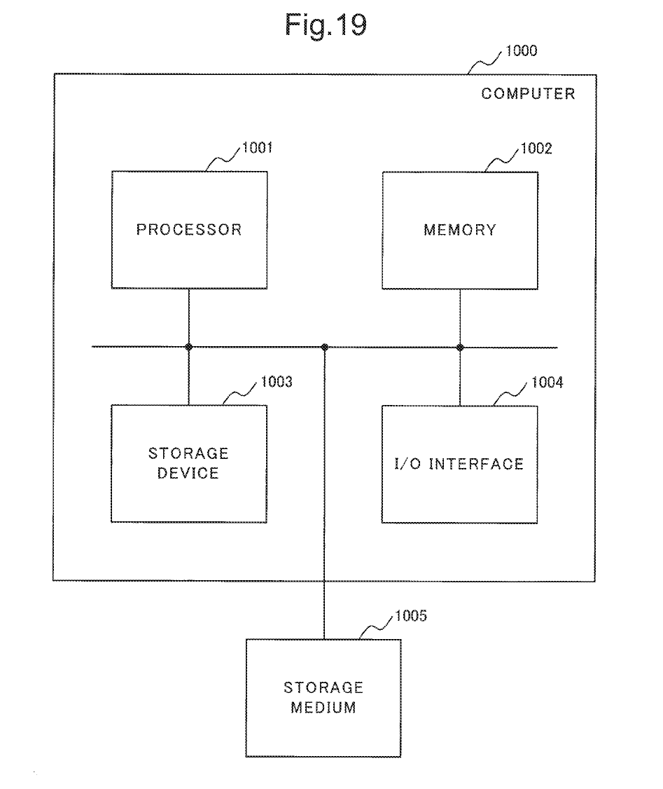

FIG. 19 is a diagram illustrating an example of a hardware configuration of a computer 1000 with which the information processing apparatus 1, the information processing apparatus 1A, the information processing apparatus 1B, and the terminal apparatus 2 can be achieved. Referring to FIG. 19, the computer 1000 includes a processor 1001, a memory 1002, a storage device 1003, and an I/O (input/output) interface 1004. The computer 1000 can access a storage medium 1005. The memory 1002 and the storage device 1003 each are a storage device, for example, a RAM (random access memory), a hard disk, or the like. The storage medium 1005 is, for example, a storage device, such as a RAM or a hard disk, a ROM (read-only memory), a portable storage medium, or the like. The storage device 1003 may serves as the storage medium 1005. The processor 1001 can read and write data and programs from and into the memory 1002 and the storage device 1003. The processor 1001 can access, for example, other apparatuses connected via the communication network 3, by using the I/O interface 1004. The processor 1001 can access the storage medium 1005. The storage medium 1005 stores a program that causes the computer 1000 to operate as the information processing apparatus 1, the information processing apparatus 1A, the information processing apparatus 1B, or the terminal apparatus 2.

The processor 1001 loads, into the memory 1002, the program that is stored on the recording medium 1005 and that causes the computer 1000 to operate the information processing apparatus 1, the information processing apparatus 1A, the information processing apparatus 1B, or the terminal apparatus 2. Then, the processor 1001 executes the program loaded into the memory 1002, so that the computer 1000 operates as the information processing apparatus 1, the information processing apparatus 1A, the information processing apparatus 1B, or the terminal apparatus 2.

The control unit 101, the relevance degree processing unit 102, the communication unit 103, the terminal control unit 201, and the terminal communication unit 205 can be achieved by the processor 1001 executing, for example, a dedicated program loaded in the memory 1002. The screen information storage unit 104, the operation information storage unit 105, and the information storage unit 204 can be achieved by the memory 1002 or the storage device 1003, such as a hard disk device, that the computer 1000 includes. All or a part of the control unit 101, the relevance degree processing unit 102, the communication unit 103, the screen information storage unit 104, and the operation information storage unit 105 can be achieved by a dedicated circuit that realizes functions of those units. All or a part of the terminal control unit 201, the input unit 202, the output unit 203, the information storage unit 204, and the terminal communication unit 205 can achieved by a dedicated circuit that realizes functions of those units.

When objects drawn on the screen of the electronic whiteboard increase in number, it becomes not easy to grasp the objects that are related with each other. Consequently, operating efficiency declines. The technology of PTL 1 (Japanese Unexamined Patent Publication No. 2009-163458 mentioned above) does not solve this problem.

The present disclosure has an advantageous effect of being able to restrain decline in operating efficiency even if objects drawn on the screen increase in number.

The whole or a part of the above-described exemplary embodiments can be described as the following supplementary notes but are not limited to the supplementary notes.

(Supplementary Note 1)

An information processing apparatus including:

a memory that stores a set of instructions; and

at least one processor configured to execute the set of instructions to:

calculate a relevance degree that indicates strength of relevance of a first area to a second area other than the first area on a basis of an operation related to the first area, the first area and the second area being in a plurality of areas in a screen shared by a plurality of terminal apparatuses; and

send the relevance degree to the plurality of terminal apparatuses, the plurality of terminal apparatuses each displaying the screen based on the relevance degree.

(Supplementary Note 2)

The information processing apparatus according to Supplementary Note 1, wherein

the at least one processor is configured further to:

calculate, when the operation is further related to the second area, the relevance degree so that the strength of relevance is strengthened.

(Supplementary Note 3)

The information processing apparatus according to Supplementary Note 1, wherein

the at least one processor is configured further to:

calculate, when a type of the operation is a specific type, the relevance degree of the first area to the second area related to a second operation included in a history of operations so that the strength of relevance is strengthened.

(Supplementary Note 4)

The information processing apparatus according to Supplementary Note 1, wherein

the at least one processor is configured further to:

calculate the relevance degree on a basis of a distance between the first area and the second area when the operation causes the distance to change.

(Supplementary Note 5)

The information processing apparatus according to Supplementary Note 1, wherein

the at least one processor is configured further to:

display marks each indicating areas in the plurality of areas in decreasing order of relevance degrees of the first area to the areas, the first area being currently selected, and, when a mark of the marks is selected, change an area indicated by the mark into the first area.

(Supplementary Note 6)

The information processing apparatus according to Supplementary Note 5, wherein

the at least one processor is configured further to:

classify the areas into groups on a basis of the relevance degrees, and display the marks that indicate the areas, separately for the groups into which the areas are classified.

(Supplementary Note 7)

The information processing apparatus according to Supplementary Note 1, wherein

the at least one processor is configured further to:

display the areas at positions based on the relevance degree of each of the areas to the first area, the first area being a currently selected area.

(Supplementary Note 8)

An information processing system including the information processing apparatus according to Supplementary Note 1, the system including:

the plurality of terminal apparatuses.

(Supplementary Note 9)

An information processing method including:

calculating a relevance degree that indicates strength of relevance of a first area to a second area other than the first area on a basis of an operation related to the first area, the first area and the second area being in the plurality of areas in a screen shared by a plurality of terminal apparatuses; and

sending the relevance degree to the plurality of terminal apparatuses, the plurality of terminal apparatuses each displaying the screen based on the relevance degree.

(Supplementary Note 10)

The information processing method according to Supplementary Note 9, wherein

the calculating includes calculating, when the operation is further related to the second area, the relevance degree so that the strength of relevance is strengthened.

(Supplementary Note 11)

The information processing method according to Supplementary Note 9, wherein

the calculating includes calculating, when a type of the operation is a specific type, the relevance degree of the first area to the second area related to a second operation included in a history of operations so that the strength of relevance is strengthened.

(Supplementary Note 12)

The information processing method according to Supplementary Note 9, wherein

the calculating includes calculating the relevance degree on a basis of a distance between the first area and the second area when the operation causes the distance to change.

(Supplementary Note 13)

The information processing method according to Supplementary Note 9, wherein

the plurality of terminal apparatuses display marks each indicating areas in the plurality of areas in decreasing order of relevance degrees of the first area to the areas, the first area being currently selected, and, when a mark of the marks is selected, change an area indicated by the mark into the first area.

(Supplementary Note 14)

The information processing method according to Supplementary Note 13, wherein

the plurality of terminal apparatuses classify the areas into groups on a basis of the relevance degrees, and display the marks that indicate the areas, separately for the groups into which the areas are classified.

(Supplementary Note 15)

The information processing method according to Supplementary Note 9, wherein

the plurality of terminal apparatuses display the areas at positions based on the relevance degree of each of the areas to the first area, the first area being a currently selected area.

(Supplementary Note 16)

A non-transitory computer-readable storage medium storing a program that causes a computer to execute:

relevance degree processing of calculating a relevance degree that indicates strength of relevance of a first area to a second area other than the first area on a basis of an operation related to the first area, the first area and the second area being in the plurality of areas in a screen shared by a plurality of terminal apparatuses; and

control processing of sending the relevance degree to the plurality of terminal apparatuses, the plurality of terminal apparatuses each displaying the screen based on the relevance degree.

(Supplementary Note 17)

The non-transitory computer-readable storage medium according to Supplementary Note 16, wherein

the relevance degree processing calculates, when the operation is further related to the second area, the relevance degree so that the strength of relevance is strengthened.

(Supplementary Note 18)

The non-transitory computer-readable storage medium according to Supplementary Note 16, wherein

the relevance degree processing calculates, when a type of the operation is a specific type, the relevance degree of the first area to the second area related to a second operation included in a history of operations so that the strength of relevance is strengthened.

(Supplementary Note 19)

The non-transitory computer-readable storage medium according to Supplementary Note 16, wherein

the relevance degree processing calculates the relevance degree on a basis of a distance between the first area and the second area when the operation causes the distance to change.

(Supplementary Note 20)

The non-transitory computer-readable storage medium according to Supplementary Note 16, wherein

the plurality of terminal apparatuses display marks each indicating areas in the plurality of areas in decreasing order of relevance degrees of the first area to the areas, the first area being currently selected, and, when a mark of the marks is selected, change an area indicated by the mark into the first area.

(Supplementary Note 21)

The non-transitory computer-readable storage medium according to Supplementary Note 20, wherein

the plurality of terminal apparatuses classify the areas into groups on a basis of the relevance degrees, and display the marks that indicate the areas, separately for the groups into which the areas are classified.

(Supplementary Note 22)

The non-transitory computer-readable storage medium according to Supplementary Note 16, wherein

the plurality of terminal apparatuses display the areas at positions based on the relevance degree of each of the areas to the first area, the first area being a currently selected area.

While the present disclosure has been described above with reference to the exemplary embodiments, the present disclosure is not limited to the exemplary embodiments. Configurations and details of the present disclosure can be changed in various manners that are within the scope of the present disclosure and that can be understood by those skilled in the art.

1. An information processing apparatus comprising:
a memory that stores a set of instructions; and
at least one processor configured to execute the set of instructions to:
calculate a relevance degree that indicates strength of relevance of a first area to a second area other than the first area on a basis of an operation related to the first area, the first area and the second area being in a plurality of areas in a screen shared by a plurality of terminal apparatuses; and
send the relevance degree to the plurality of terminal apparatuses, the plurality of terminal apparatuses each displaying the screen based on the relevance degree.

2. The information processing apparatus according to claim 1, wherein
the at least one processor is configured further to:
calculate, when the operation is further related to the second area, the relevance degree so that the strength of relevance is strengthened.

3. The information processing apparatus according to claim 1, wherein
the at least one processor is configured further to:
calculate, when a type of the operation is a specific type, the relevance degree of the first area to the second area related to a second operation included in a history of operations so that the strength of relevance is strengthened.

4. The information processing apparatus according to claim 1, wherein
the at least one processor is configured further to:
calculate the relevance degree on a basis of a distance between the first area and the second area when the operation causes the distance to change.

5. The information processing apparatus according to claim 1, wherein
the at least one processor is configured further to:
display marks each indicating areas in the plurality of areas in decreasing order of relevance degrees of the first area to the areas, the first area being currently selected, and, when a mark of the marks is selected, change an area indicated by the mark into the first area.

6. The information processing apparatus according to claim 5, wherein
the at least one processor is configured further to:
classify the areas into groups on a basis of the relevance degrees, and display the marks that indicate the areas, separately for the groups into which the areas are classified.

7. The information processing apparatus according to claim 1, wherein
the at least one processor is configured further to:
display the areas at positions based on the relevance degree of each of the areas to the first area, the first area being a currently selected area.

8. An information processing system including the information processing apparatus according to claim 1, the system comprising:
the plurality of terminal apparatuses.

9. An information processing method comprising:
calculating a relevance degree that indicates strength of relevance of a first area to a second area other than the first area on a basis of an operation related to the first area, the first area and the second area being in the plurality of areas in a screen shared by a plurality of terminal apparatuses; and
sending the relevance degree to the plurality of terminal apparatuses, the plurality of terminal apparatuses each displaying the screen based on the relevance degree.

10. A non-transitory computer-readable storage medium storing a program that causes a computer to execute:
relevance degree processing of calculating a relevance degree that indicates strength of relevance of a first area to a second area other than the first area on a basis of an operation related to the first area, the first area and the second area being in the plurality of areas in a screen shared by a plurality of terminal apparatuses; and
control processing of sending the relevance degree to the plurality of terminal apparatuses, the plurality of terminal apparatuses each displaying the screen based on the relevance degree.
